(19) United States
(12) Patent Application Publication
(10) Pub. No.: US 2025/0390731 A1
(43) Pub. Date: Dec. 25, 2025

(54) EMBEDDING NEURAL NETWORK ON SILICON THROUGH DIE-TO-DIE INTERCONNECT

(71) Applicant: Intel Corporation, Santa Clara, CA (US)

(72) Inventors: Yaron Klein, Rosh Haayin (IL); Yoni Elron, Hadera (IL); Yuval Vered, Tel-Aviv (IL)

(73) Assignee: Intel Corporation, Santa Clara, CA (US)

(21) Appl. No.: 19/312,927

(22) Filed: Aug. 28, 2025

Related U.S. Application Data
(60) Provisional application No. 63/721,670, filed on Nov. 18, 2024.

(51) Int. Cl. G06N 3/063

(52) U.S. Cl. CPC G06N 3/063

(57) ABSTRACT

An integrated circuit (IC) device may implement a neural network model. The IC device may include stacked embedding dies, stacked attention dies, and a base die. The embedding dies may perform embedding computations in the model. Each embedding die may have an embedding dot unit that includes memories for storing precomputed embedding vectors, multiply units for performing multiplication operations on embeddings, add units for summing the results of the multiplication operations. The attention dies may perform attention computations in the model. Each attention die may have an attention dot unit that includes memories for storing intermediate values, multiply units for performing multiplication operations for attention mechanisms, add units for summing the results of the multiplication operations. The base die may coordinate the overall operation of the model and perform preprocessing, embedding, normalization, activation, and final output generation. Micro-bumps may provide electrical connections between the stacked dies, facilitating inter-die communication.

### CROSS-REFERENCE TO RELATED APPLICATION

This application claims the benefit of U.S. Provisional Patent Application No. 63/721,670, filed Nov. 18, 2024, and titled “HYBRID SYSTEM WITH INTERCONNECT FOR HARDWARE-EMBEDDED NEURAL NETWORK MODEL AND WEIGHTS,” which is incorporated by reference in its entirety for all purposes.

### TECHNICAL FIELD

This disclosure relates generally to artificial intelligence (AI), and more specifically, embedding neural networks (also referred to as “deep neural networks” or “DNNs”) on silicon through die-to-die interconnects.

### BACKGROUND

DNNs are used extensively for a variety of AI applications ranging from natural language processing to computer vision, speech recognition, and image processing due to their ability to achieve high accuracy. However, the high accuracy comes at the expense of significant computation cost. DNNs have extremely high computing demands as there can be a large number of operations as well as a large amount of data to read and write. Therefore, techniques to improve efficiency of DNNs are needed.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an integrated circuit (IC) device that implements a model on silicon, in accordance with various embodiments.

FIG. 2 illustrates a model-on-silicon device with dies, in accordance with various embodiments.

FIG. 3 illustrates a stack of dies with memory and compute components, in accordance with various embodiments.

FIG. 4 illustrates bumps that provide electrical connections between stacked dies, in accordance with various embodiments.

FIG. 5 illustrates an embedding dot unit, in accordance with various embodiments.

FIG. 6 illustrates a sequential read-only memory (ROM), in accordance with various embodiments.

FIG. 7 illustrates an attention multiplier unit with a sequential read/write memory, in accordance with various embodiments.

FIG. 8 illustrates an example transformer model, in accordance with various embodiments.

FIG. 9 illustrates the first inference process of a transformer model, in accordance with various embodiments.

FIG. 10 illustrates subsequent inference processes of the transformer model, in accordance with various embodiments.

FIG. 11 is a block diagram of an example computing device, in accordance with various embodiments.

### DETAILED DESCRIPTION

The last decade has witnessed a rapid rise in AI based data processing, particularly based on neural networks (also referred to as deep neural networks (DNNs)). DNNs are widely used in various domains (e.g., language processing, computer vision, speech recognition, autonomous driving, image processing, video processing, etc.) mainly due to their ability to achieve beyond human-level accuracy. A DNN typically includes a sequence of layers. A DNN layer may include one or more deep learning operations (also referred to as “neural network operations”), such as embedding operation, matrix multiplication (MatMul), layer normalization, batch normalization, activator operations (e.g., Sigmoid linear unit (SiLU) operation, SoftMax operation, etc.), pooling, elementwise operation, linear operation, nonlinear operation, and so on.

Currently, the deployment and execution of complex models are often carried out on high performance Graphics Processing Units (GPUs). While GPUs can provide computational horsepower to handle these sophisticated models, they typically come with significant drawbacks, including high power consumption and latency issues. These limitations become especially problematic in environments where real-time processing and power efficiency are critical, such as in mobile devices, edge computing, and Internet of Things (IoT) applications. Additionally, large models, which are the backbone of Large Language Models (LLMs) and other state-of-the-art deep learning applications, are predominantly based on the transformer architecture and its attention module. These larger models usually require more room on the silicon (Si), which becomes an issue with the monolithic die architecture. The problem can escalate during inference, where every token generated requires the calculation of attention for the entire sequence, leading to a quadratic dependency on sequence length. This design limitation restricts the maximum size of the model that can fit within a given form factor, hindering the deployment of larger and potentially more powerful models.

Executing advanced models like transformers on GPUs presents inherent challenges due to several technical constraints, such as model size and silicon real estate as well as model size and performance limitations. The first major issue revolves around the physical dimensions of the models. Large models like Transformers and LLMs typically require more space on the silicon chip, which is a problem when using a monolithic die architecture. This limitation restricts the maximum size of the model that can fit within a given form factor, thereby limiting the deployment of larger and potentially more powerful models. On AI personal computers or any edge solutions, even when using a Neural Processing Unit (NPU), there are still significant limitations regarding the size of the model that can be deployed and the performance that can be achieved. NPUs, while designed to be more efficient than GPUs, are still constrained by memory and computational capacity, which affects the feasibility of running large, complex models like Large Language Model Meta AI (LLaMA) effectively in edge environments.

In a setup based on a general-purpose GPU, model weights are typically loaded from memory every time an inference task is undertaken. While GPUs can provide versatility, capable of managing a broad spectrum of tasks, this flexibility can result in compromises in areas like optimization, power consumption, and latency. Specifically, general-purpose GPUs, despite having stacked memory, do not perform computations within the memory. Consequently, data frequently shuttles between the memory and the GPU compute units, leading to high-bandwidth transactions. This process is power-intensive and time-consuming, especially for complex models. Furthermore, the design of GPUs to handle a variety of tasks makes them inefficient for dedicated tasks such as inference on a pretrained model.

Another solution involves the use of a monolithic die, where model weights are incorporated directly onto the silicon. This setup can eliminate the need to continually load them from memory for each inference task. While this solution can significantly reduce power consumption and latency by avoiding high-bandwidth transactions between memory and compute units, it introduces its own set of challenges. The physical dimension of the chip limits the size of the model that can be deployed. Furthermore, as technology advances and models become more complex, the monolithic die may not provide the room for expansion, limiting the ability to adapt to future needs. This calls for a more scalable approach, like a stacked die design, to accommodate the evolving demands of AI and machine learning applications.

Some AI inference tasks are based on NPUs. NPUs are usually specialized hardware designed explicitly for AI tasks, particularly inference on pretrained models. They are optimized for the types of computations required in deep learning, such as matrix multiplications and convolutions, and can handle large-scale model weights more efficiently than general-purpose hardware. NPUs, similar to GPUs, provide flexibility for deep learning tasks, this flexibility also comes at the expense of limitation in the model size and context input.

Central Processing Units (CPUs) are also used for AI inference tasks. By loading the model on them. CPUs are usually not suitable for large-scale matrix multiplications which are essential for AI inferencing tasks. They also consume more power and are slower in comparison to dedicated solutions.

Dedicated accelerators are also used for AI inference tasks. Dedicated accelerators are usually designed specifically for AI training and inference tasks. These accelerators offer high performance and efficiency for specific AI workloads by optimizing hardware for the unique demands of deep learning computations. They can handle large-scale models and complex operations more effectively than general-purpose hardware. While dedicated accelerators provide unparalleled performance for AI tasks, they still require frequent data movement between memory and processing units, which can introduce latency and reduce overall efficiency. This need for data transfer can limit their effectiveness for tasks that require rapid and extensive memory access.

Some solutions use AI processors. These processors can significantly outperform traditional edge AI processors in terms of area and power efficiency. Utilizing a unique, powerful, and scalable structure-driven dataflow architecture, AI processors take advantage of the core properties of neural networks. This enables edge devices to run deep learning applications at full scale more efficiently, effectively, and substantially than traditional solutions, while significantly lowering costs. Despite their impressive performance and efficiency, AI processors are often optimized for very small models and are not efficient for larger models where data needs to move back and forth from memory, impacting overall performance and efficiency. And they are still not real-time.

Field Programmable Gate Arrays (FPGAs) are another solution used for AI inference. They are programmable hardware that can be customized to perform specific tasks, including loading and handling LLM weights. While FPGAs offer flexibility, they have significantly lower performance compared to dedicated hardware solutions and are not as power-efficient and not cost-effective.

Embodiments of this disclosure may improve on at least some of the challenges and issues described above by embedding a DNN on an IC device that includes distinct types of dies and a fabric that connects the dies. An example of the DNN is a transformer-based model, such as an LLM. An example of the IC device is a silicon chip. An example of the fabric is an Embedded Multi-die Interconnect Bridge (EMIB) fabric with micro-bumps. This disclosure provides a dedicated, real-time, efficient, and cost-effective solution for machine learning inference.

In various embodiments of this disclosure, a DNN is embedded onto an IC device. The IC device may implement the model architecture and internal parameters (e.g., weights) of the DNN. The IC device may include three types of dies: embedding dies, attention dies, and a base die. Each embedding die or attention die may include both memory and compute components. The embedding dies may be used to perform embedding computations in the model. The embedding dies may compute dense vector representations of input tokens, which may be essential for subsequent processing in the model. Each embedding die may include an embedding dot unit. The embedding dot unit may include memories (such as sequential ROMs or RAMs) for storing precomputed embedding vectors, multiply units for performing multiplication operations on embeddings, add units for summing the results of the multiplication operations. The attention dies may be used to perform attention computations in the model. The attention dies may compute attention scores and weighted sum of value vectors, which may be critical for capturing dependencies and relationships between different parts of the input data. Each attention die may include an attention dot unit. The attention dot unit may include memories (such as sequential RAMs) for storing intermediate values, multiply units for performing multiplication operations for attention mechanisms, add units for summing the results of the multiplication operations. The base die may perform preprocessing, embedding, normalization, activation, and final output generation. The base die may also coordinate the overall operation of the model. For instance, the base die may orchestrate the embedding computations by the embedding dies, the attention computations by the attention dies, and the computations by various components of the base die.

The embedding dies may be stacked over each other. The attention dies may be stacked over each other. The stacked embedding dies, stacked attention dies, and base die may be separated. The separation can ensure that each type of computation is optimized for its specific requirements, improving overall performance and efficiency. The separate sections of the IC device can be orchestrated through die-to-die interconnection. An example of the die-to-die interconnection may include an EMIB fabric, which can provide a high-bandwidth, low-latency interconnect between the different dies, enabling efficient communication and data transfer. In an example, data may be transferred between the base die and the stacked embedding dies, between the base die and the stacked attention dies, or between the stacked embedding dies and the stacked attention dies. Micro-bumps may be placed between stacked dies to form an electrical connection between the stacked dies. Data may be transferred from the base die to an embedding die (or attention die) through one or more other embedding dies (or attention dies). By incorporating specialized dies onto a silicon chip and harnessing the EMIB-like fabric, the model architecture and weights can be directly embedded into the IC device. This design can optimize processing speed, power efficiency, and overall performance in AI tasks, resulting in enhanced context handling and improved accuracy.

The approach in this disclosure has many advantages compared with currently available solutions described above. An advantage is scalability and flexibility. One of the significant challenges in deploying large models like LLaMA is the physical space constraints on a silicon chip. The monolithic die approach has limitations in terms of scalability and flexibility. However, the approach in this disclosure can overcome this by using a stacked and separated die approach. By dividing the LLM into three specialized dies and stacking them, the approach in this disclosure can effectively utilize the vertical space, thereby increasing the scalability of the model. This design can not only allow for larger models to be deployed but also provide the flexibility to adapt to future needs and technological advancements. Furthermore, by separating the dies based on their specific computational tasks, this approach can optimize each die individually, thereby improving the overall performance and efficiency of the system. This unique design addresses the area problem inherent in large models, making the deployment of such models more feasible and efficient.

Another advantage is performance boost. In contrast to general-purpose GPUs or FPGAs, dedicated chips in this disclosure can be purpose-built for AI inference tasks. This can result in a significant reduction in overhead costs associated with unnecessary or general-purpose functionalities, making this solution more cost-effective. Moreover, this design can incorporate Sequential ROM-based and Sequential RAM-based Compute-in-Memory dies, which not only reduces costs related to dynamic memory management but also addresses the data movement problem commonly associated with traditional architectures. By integrating memory and computation, it can eliminate the need to move data between separate memory and processing units, thereby reducing power consumption and latency, and further enhancing cost-effectiveness. This Compute-in-Memory approach represents a significant leap forward in the efficiency and cost-effectiveness of AI hardware solutions.

Yet another advantage is real-time computing. The power efficiency and performance boost offered by this disclosure can make it ideal for edge computing, mobile, and IoT applications where resources are limited, and low latency is required. The efficient data and computational result movement enabled by the EMIB fabric supports real-time computing needs, making the solution highly suitable for time-sensitive applications.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

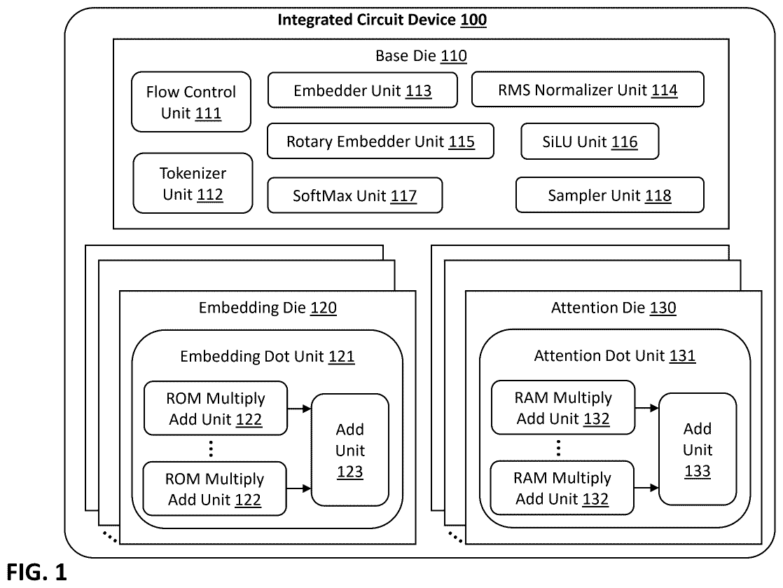

FIG. 1 illustrates an IC device 100 that implements a model on silicon, in accordance with various embodiments. In some embodiments, the IC device 100 may be a hardware implementation of a DNN, such as a transformer-based model. An example of the DNN is an LLM. At least part of the model architecture, weights, and flow of the DNN can be embedded into the IC device 100. For instance, the IC device 100 may include memories that store the weights of the DNN. The IC device 100 may also include compute units that are mapped to the operators in the DNN. In some embodiments, the IC device 100 may be a chip, such as a silicon chip.

As shown in FIG. 1, the IC device 100 includes a base die 110, stacked embedding dies 120 (individually referred to as “embedding die 120”), and attention dies 130 (individually referred to as “attention die 130”). The base die 110 includes a flow control unit 111, tokenizer unit 112, embedder unit 113, root mean square (RMS) normalizer unit 114, rotary embedder unit 115, SiLU unit 116, SoftMax unit 117, and sampler unit 118. A unit in the IC device 100 may be a circuit or may include multiple circuits. In other embodiments, the IC device 100 may include fewer, more, or different components. For example, the base die 110 may include more than one flow control unit 111, tokenizer unit 112, embedder unit 113, RMS normalizer unit 114, rotary embedder unit 115, SiLU unit 116, SoftMax unit 117, or sampler unit 118. As another example, the units may be arranged in fewer, more, or different dies of the IC device 100. Further, functionality attributed to a component of IC device 100 may be accomplished by a different component included in the IC device 100 or a different device.

The flow control unit 111 manages data flow between various components of the IC device 100. In some embodiments, the flow control unit 111 plays a role in orchestrating various components (e.g., units) of the IC device 100 to execute operations according to a predetermined timing sequence. The flow control unit 111 may also be referred to as a sequencer unit, which can orchestrate one or more other components of the IC device 100 according to a predetermined timing sequence of the DNN. In an example, the flow control unit 111 may control and ensure that the tokenizer unit 112 converts input tokens and passes them to the embedding sections, such as the embedder unit 113, the rotary embedder unit 115, and embedding dies 120; the embeddings are then processed and passed to the attention dies 130 for attention computation; the attention results are then normalized by the RMS normalizer unit 114, activated by the SiLU unit 116, and passed through the SoftMax unit 117 to generate output probabilities; finally, the sampler unit 118 samples from the output distribution and generates the final output tokens.

In some embodiments, the DNN operates in a feedforward manner. In an example, the DNN may include a sequence of layers. A layer may have one or more operators. For a layer having multiple operators, the operators may be arranged in the sequence. Each operator may correspond to a neural network operation. For example, a MatMul operator specifies a MatMul operation. The sequence of all the operators in the DNN may be predetermined as a part of the model architecture of the DNN. In some embodiments, the spatial shape of the input tensor(s) and output tensor of an operator can also be predetermined. During inference, data flows through the operators in the DNN in the predetermined sequence. The predetermined sequence of the operators in the DNN can be mapped into a timing sequence of various components of the IC device 100 executing the corresponding neural network operations. The timing sequence of neural network operations may include stages of operations, one following another. In a particular time slot or stage in the timing sequence, data can be moved in, processed, and moved out to be processed in the next/following time slot, in a feedforward, progressive manner.

In some embodiments, the flow control unit 111 may implement digital logic to generate clock edges/signals (e.g., control signals, timing signals, enable signals, disable signals, trigger signals, etc.) to orchestrate operations to be performed according to the timing sequence. The flow control unit 111 may control data flow into or out of one or more other components of the IC device 100. The flow control unit 111 may also enable or disable one or more other components of the IC device 100 according to a predetermined timing sequence.

The tokenizer unit 112 is a hardware implementation of a tokenizer in the DNN. In an example, the tokenizer unit 112 is a hardware-based tokenizer for an LLM. The tokenizer unit 112 may convert raw data (e.g., words) to tokens. For instance, the tokenizer unit 112 may use the DNN's vocabulary to convert works received from a user to tokens that can be further processed by other operators in the DNN. The vocabulary may be predefined vocabulary. In some embodiments, the vocabulary of the DNN is implemented on the tokenizer unit 112. For instance, the vocabulary may be stored in a data storage unit of the tokenizer unit 112. The tokenizer unit 112, after receiving words, may compare the words with the vocabulary to determine indices of tokens corresponding to the words. The tokenizer unit 112 may output the token indices.

In some embodiments, the tokenizer unit 112 includes a cycle buffer, comparator, memory, ID block, and multiplexer (MUX). The cycle buffer may receive and store data received by the tokenizer unit 112. The data may be the input data of the DNN. The input data may be one or more words that need to be tokenized. In some embodiments, the tokenizer unit 112 may have a different type of data storage unit from the cycle buffer for storing input data. The comparator retrieves input data from the cycle buffer and compares the word(s) with the vocabulary of the DNN. The vocabulary of the DNN is stored in the memory. The memory may be a ROM, such as a sequential ROM. The memory may store a list of vocabulary entries, which are predefined words or tokens. Each vocabulary entry corresponds to a unique Token ID. The ID block stores the Token IDs associated with each vocabulary entry. When the comparator finds a match in the vocabulary, the ID block receives the corresponding Token ID. After a Token ID is retrieved, it is output through the ID block. The comparator may access the vocabulary in the memory to find a match for each word in the input data. When a match is found, the corresponding Token ID is fetched from the ID block and provided to the MUX. The MUX may output the Token ID as an output of the tokenizer unit 112. In some embodiments, the output of the Token ID from the MUX may be controlled by a signal from the comparator. The signal may indicate that a match has been found.

The embedder unit 113 may implement an embedder (e.g., an embedding layer) of the DNN. The embedder unit 113 may execute the embedding layer to convert tokens (such as tokens generated by and received from the tokenizer unit 112) to embedding vectors. In some embodiments, the embedder unit 113 may include look-up tables that map tokens to embedding elements. The look-up tables may output embedding elements corresponding to input tokens. The embedding elements may constitute the embedding vector of the input tokens.

In an example, the embedder unit 113 includes 256 look-up tables. The look-up tables may have the same storage size, e.g., 1000 KB. Each of the look-up tables may have 112,000 lines. In some embodiments, the look-up tables may be implemented on one or more ROMs. In an example, the 256 look-up tables are implemented on 256 ROMs, respectively. The embedder unit 113 may receive an input token. In the example shown in FIG. 1, the embedder unit 113 receives an input token represented by 15 bits. The input token may have an integer format. The embedder unit 113 may also receive control signals. For instance, the embedder unit 113 receives an embedder cycle signal, which may have 10 bits. The embedder unit 113 also receives an embedder run signal, which may have 1 bit. The embedder unit 113 may also receive an embedder on/off signal, which may have 1 bit.

The output of the embedder unit 113 may be an embedding vector. For instance, the embedder unit 113 may produce an embedding vector with floating-point (e.g., FP16) data elements. The dimension of the embedding vector may indicate the total number of data elements in the embedding vector. In an example, the dimension of the embedding vector may be 10,096. In some embodiments, the embedder unit 113 may receive 32,000 tokens. The total embedder size may be 250 MB, which equals 10,096×32,000×2B. Each of the tokens in the vocabulary may be broken into 16 chunks of 256 numbers. In some embodiments (e.g., embodiments where the look-up tables are stored in ROMs), the first out of 16 numbers may be read from the table. Reading from the ROM may be sequential for 16 cycles, so the next line is to be pre-charged but it may be unnecessary to pre-charge other lines. Within each cycle, the 256 look-up tables may output 256 embedding vector elements, respectively. The embedder unit 113 may return 256 elements every clock cycle for 16 clocks cycles. After finishing the 16 cycles, the embedder unit 113 may be idle for about 10,000 cycles. Power gating may be used.

The RMS normalizer unit 114 may normalize data using RMS normalization. The RMS normalizer unit 114 may implement one or more RMS normalizer functions in the DNN. An RMS normalizer function may be denoted as:

$$\frac{{x}_{i} \cdot {W}_{R M {S}_{i}}}{\sqrt{\frac{{\sum }_{j = 0}^{4 , 096} {x}_{j}^{2}}{4 , 096} + 1 {0}^{- 5}}}$$

In some embodiments, the RMS normalizer unit 114 may receive an input vector (e.g., 4096 FP16 elements) and return an RMS-normalized vector (e.g., 4096 elements in FP8 format). The RMS normalizer unit 114 may receive 256 elements every clock for 16 clocks cycles. The RMS normalizer unit 114 may include tree adder 1502 to add a number of values (e.g., 256 values) together simultaneously. The RMS normalizer unit 114 may include ROM 1504 storing a look-up table comprising one or more precomputed values of the function:

$$f ( x ) = {\sqrt{\frac{x}{4 , 096} + 1 {0}^{- 5}}}^{- 1} .$$

The rotary embedder unit 115 may apply rotary positional embeddings on input data. The rotary embedder unit 115 is the hardware implementation of one or more rotary position encoders in the DNN. The rotary embedder unit 115 may produce rotary positional encoded embeddings. In some embodiments, the rotary embedder unit 115 may provide the functionality of a sine cosine unit without the need to calculate/compute sine and cosine in real-time. The rotary embedder unit 115 may have a sine cosine unit that has a look-up table implementation. In some embodiments, the rotary embedder unit 115 may include a look-up table comprising one or more precomputed values of a cosine function

$$( e . g . , f ( t ) cos ( {10}^{\frac{{h}_{n}}{16}} \cdot t ) ) .$$

The rotary embedder unit 115 may include another look-up table comprising one or more precomputed values of sine function

$$( e . g . , f ( t ) = sin ( {10}^{- \frac{{h}_{n}}{16}} \cdot t ) ) .$$

The SiLU unit 116 is a hardware implementation of one or more SiLU activators in the DNN. The SiLU unit 116 may include a look-up table having one or more precomputed values of a SiLU function:

$$f ( x ) = \frac{x}{1 + {e}^{- x}}$$

In some cases, the SiLU unit 116 includes a MUX controller and a MUX. The MUX controller may check whether the input value meets a particular condition and selects a particular value to use as the output of SiLU unit 116. The MUX controller may output a 2-bit value as selection signal for the MUX, to select one of three possible values to use as the output. For example, when the sign bit is 0 and the most-significant bits (MSBs) of the input are “11”, the input is selected by the MUX and passed on to use as the output. When the sign bit is 1 and the MSBs of the input are “11”, the value of “0” is selected by the MUX to use as the output. Otherwise, the value from the look-up table is used as the output.

The SoftMax unit 117 is a hardware implementation of one or more SoftMax activators in the DNN. The SoftMax unit 117 may implement a SoftMax function for output probability distribution. In some embodiments, the SoftMax unit 117 may execute a SoftMax function using one or more look-up tables that are pre-configured with precomputed data. The SoftMax function may be:

$$\frac{{e}^{\frac{{x}_{i} - {x}_{max}}{\sqrt{128}}}}{{\sum }_{j = 0}^{t} {e}^{\frac{{x}_{j} - {x}_{max}}{\sqrt{128}}}}$$

In some embodiments, the SoftMax unit 117 includes look-up table implementation of the SoftMax function instead of a compute-oriented solution. In some embodiments, the SoftMax unit 117 receives an input vector of t FP16 elements (1<t<512) and returns the SoftMax normalized vector of the same size. The SoftMax unit 117 receives 16 numbers per cycle for up to 32 cycles and returns 16 numbers per cycle for up to 32 cycles.

In an example, the SoftMax unit 117 receives an input vector including 16 elements, each of which is a FP16 value, in a clock cycle. The total number of bits of the input vector is 256. The SoftMax unit 117 may also receive a compare control signal, normalize control signal, exponent control signal, multiply control signal, on/off control signal, other types of control signals, or some combination thereof. A control signal may have 1 bit. The output of the SoftMax unit 117 may be 16 elements with UFP16 format. The total number bits may be 240. The SoftMax unit 117 may execute the SoftMax function using 16 clock cycles. Numbers may be stored in a first-in-first-out (FIFO) buffer while they are compared to find the largest number in the vector. The FIFO buffer may output numbers. The largest number may be subtracted. The subtraction result is provided to a look-up table. The output of the look-up table enters a second FIFO. Numbers may be pulled out of the second FIFO and multiplied by the normalization value. It may take a total of 24 cycles to compute the output. The 24 cycles may include 8 latency cycles and 16 piping cycles

In some embodiments, the SoftMax unit 117 may be included in the attention dot unit 131 to perform SoftMax on an input vector (e.g., FP16 vector) and to output a SoftMax-ed vector (e.g., FP16 vector). The SoftMax unit 117 may include a look-up table comprising one or more precomputed values of an exponent function:

$$f ( x ) = {e}^{\frac{x}{\sqrt{128}}} .$$

The SoftMax unit 117 may include another look-up table comprising one or more precomputed values of a reciprocal function:

$$f ( x ) = \frac{1}{x} .$$

The SoftMax unit 117 may include a tree adder that can add a number of values (e.g., 18 values) together simultaneously.

The sampler unit 118 is a hardware implementation of one or more samplers in the DNN. The sampler unit 118 may sample from the output distribution. In some embodiments, the sampler unit 118 may receive an input vector and compare elements of the input vector to find the largest value. The sampler unit 118 may determine the index of the largest number and return a token. In some embodiments, the sampler unit 118 may receive a logits vector. In an example, the vector may include 32,000 elements. In some embodiments, the sampler unit 118 may receive 256 input elements for a cycle and may take 125 cycles to process the 32,000. The input elements may be in FP16 format. The total number of bits for the 256 input elements may be 4,096 bits. In some embodiments, the 256 input elements may be received from 256 MatMul units, such as 256 attention dot units, respectively. In some embodiments, the sampler unit 118 may implement a deterministic sampler having zero temperature. The sampler unit 118 may also receive control signals, such as an on/off signal indicating whether the sampler unit 118 is to be on or off, a restart signal indicating whether to restart the sampler unit 118, and a run signal. A control signal may have 1 bit. The sampler unit 118 may determine an index, such as a 32-bit index, corresponding to the largest number in the input vector. The index may correspond to an output token. In some embodiments, the output token may be a 15-bit integer.

In some embodiments, the sampler unit 118 includes 256 sampling comparators. In other embodiments, the sampler unit 118 may include a different number of sampling comparators. With the 256 sampling comparators, the sampler unit 118 can compare 256 input elements every clock cycle and keeps the index and value of the largest number. Each sampling comparator may compare two logits or values in a single clock cycle and return the larger number of its index (token). Each value may have 16 bits and may be in the FP16 format. The index (token) may be a 15-bit integer. The output may include the larger value as well as the index of the larger value. In a situation where more than one number has the largest value, the sampler unit 118 may return the token with the lowest index out of the equal tokens. When finishing the 125 clock cycles, the sampler unit 118 returns the token of the largest value in the input vector. For instance, the sampler unit 118 may output the index of the largest value in the input vector.

In some embodiments, the sampler unit 118 may have sampling comparators arranged in a tree or hierarchical structure to efficiently compare a large number of values (e.g., hundreds or thousands of values or more) simultaneously. For instance, each comparator in the first tier may compare two values in the input vector and select the larger value, each comparator in the second tier may compare two values from two comparators, respectively, in the first tier, each comparator in the third tier may compare two values from two comparators, respectively, in the second tier, and so on. The last tier may include a comparator that outputs the largest value of the input vector. In some embodiments, the sampler unit 118 may have a latency of 9 clock cycles. Every layer of comparators may be pipeline. In some embodiments, the sampler unit 118 may have power gating.

In some embodiments, the base die 110 implements activation embedder tokenizer with SoftMax. As described above, the base die 110 may include components such as look-up table based SiLU activation, SoftMax function, RMS normalizer, and sampler. These modules can handle the activation functions, normalization, and tokenization processes, culminating in the SoftMax function that generates the final output probabilities. The base die 110 can manage intensive compute tasks and controls the overall operation of the IC device 100.

The embedding dies 120 are hardware implementation of embedding computations in the DNN. For instance, the embedding dies 120 may implement MatMul operators and add operators in the DNN, such as the MatMul operators and add operators in one or more encoders of the DNN. The embedding dies 120 may handle the initial embedding of tokens, performing matrix multiplications to transform input data into a suitable format for the DNN. The embedding dies 120 may convert input tokens into dense vector representations, which may be essential for subsequent processing in the DNN. In some embodiments, the embedding dies 120 are compute-in-memory dies, which hold the static weights of the DNN. The static weights may be weights that do not change during inference of the DNN. As shown in FIG. 1, an embedding die 120 includes an embedding dot unit 121. The embedding dot unit 121 includes a plurality of ROM multiply add units 122 (individually referred to as “ROM multiply add unit 122”) and an add unit 123. This ROM-based design can ensure efficient storage and quick access to static weights, enhancing the speed and efficiency of embedding operations.

In some embodiments, each ROM multiply add unit 122 may include one or more multipliers, ROMs, and tree adders. In one implementation, a ROM multiply add unit 122 may carry out a (4096-elements) dot product operation between FP8 embedding vector and FP6 weights vector. The dot product operation can be performed using one or more tree adders and one or more multipliers in the ROM multiply add unit 122. A multiplier may multiple two values, such as two floating-point values. The two values may have different data formats or precisions. For example, the ROM multiply add unit 122 may include one or more FP4/FP6 multipliers, one or more FP4/FP8 multipliers, or one or more FP6/FP8 multipliers. One or more multipliers in the ROM multiply add unit 122 may be specifically designed to perform multiplication of values or data having predetermined representations (e.g., FP4, FP6, FP8, FP12, INT8, etc.).

In some embodiments, the ROM multiply add units 122 may perform MatMul operations. A MatMul operation may be performed on a weight tensor and an input tensor. The input tensor may be the output of the previous operators in the DNN. Weight tensors used by the ROM multiply add units 122 may be stored in the ROMs. In some embodiments, the ROMs may be placed in proximity to the multipliers. Each multiplier may be coupled with and proximate to a corresponding ROM and may receive data (e.g., one or more weights) from the ROM. As data is located where it is needed, the ROM multiply add units 122 can be very efficient. In some embodiments, the ROMs may be sequential ROMs. Sequence read-only memory is a type of memory storage, utilizing ROMs, that allows data to be read sequentially but not written or modified after the values have been etched onto the ROM. The rest of the ROM can be shut down to reduce power and area.

In an example, a sequential ROM has six word lines. The sequential ROM can power up an active current word line and an active next word line at a time, while other word lines can be powered down. The active current word line refers to the word line having data being used or processed by a circuit to perform an operation during a time slot in the predetermined timing sequence. The active next word line refers to the word line having data being used or processed by the circuit to perform an operation during a further/next time slot in the predetermined timing sequence. The sequential ROM can power down the rest of the word lines, or the rest of the word lines in the sequential ROM can remain powered down. At the next clock or time slot, the active current word line is powered down, the active next word line is already powered up, and a further active next word line is powered up. At every clock or time slot, two word lines may be powered up in the sequential ROM. The two active word lines that are powered up may get moved by one word line down the sequential ROM at every clock or time slot.

In some embodiments, the IC device 100 may have 1,048,576 ROMs (e.g., sequential ROMs) for storing weights. A ROM may hold weights in FP6 format. A ROM output may be a 6-bit value. A weights ROM may hold a specific weight matrix column, since a weights ROM can output a single number out of the 4096-element vector being multiplied in the EDU. A weights ROM may hold one of 256 weight matrix rows, e.g., when there are 256 embedding dot units working in parallel and producing 256 numbers per clock cycle. A ROM may hold matrix rows 1, 257, . . . , and another ROM can hold matrix rows 2, 258, and so forth. In some cases, a weights ROM may hold elements from (all) weights matrices in (all) layers, since a weights ROM sequentially outputs the number the matrix multiplier is using for (all) transformers and matrices, as the weights multipliers are shared across all layers and weights matrices. The weights ROM may hold (only) the linear layers' weights. There may be one or more dedicated ROMs for the embedder unit and RMS normalizer unit.

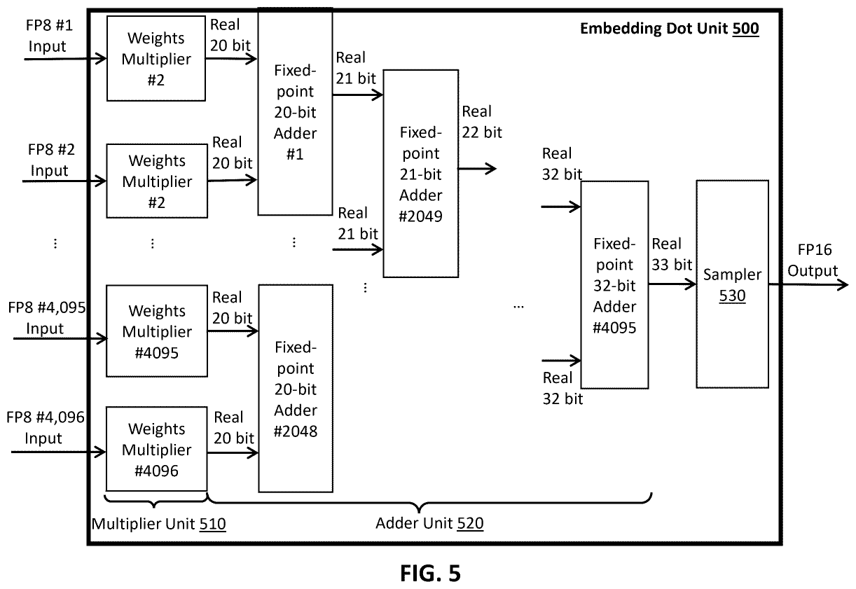

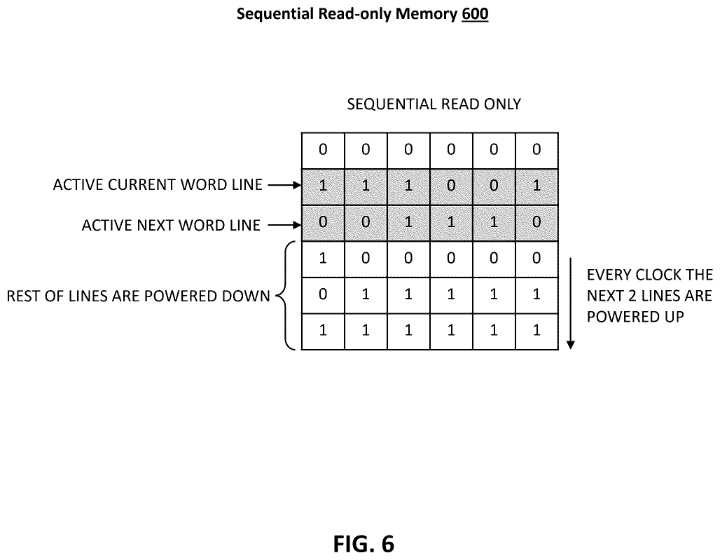

The tree adders in the ROM multiply add units 122 may add multiplication results produced by the multipliers together. A tree adder may also be referred to as an adder tree and may include adders arranged in a tree structure. The add unit 123 may add outputs of the ROM multiply add units 122. Certain aspects of the embedding dot unit 121 are described below in conjunction with FIG. 5 and FIG. 6.

The attention dies 130 are hardware implementation of attention computations in the DNN. For instance, the attention dies 130 may implement MatMul operators and add operators in the DNN, such as the MatMul operators and add operators in one or more decoders of the DNN. The attention mechanism may be critical for understanding the relationships between different parts of the input sequence. The attention dies 130 may focus on the computation of attention scores and the weighted sum of value vectors, which may be critical for capturing dependencies and relationships between different parts of the input data. The attention dies 130 may be compute-in-memory dies. The attention dies 130 may utilize sequential RAM to handle the dynamic nature of attention computations. This sequential RAM-based design can allow for fast and efficient computation of attention scores, leveraging high memory bandwidth and low latency to optimize performance.

As shown in FIG. 1, each attention die 130 includes an attention dot unit 131. The attention dot unit 131 includes a plurality of RAM multiply add units 132 (individually referred to as “RAM multiply add unit 132”) and an add unit 133. In some embodiments, each RAM multiply add unit 132 may include one or more multipliers, RAMs, and tree adders. In one implementation, a RAM multiply add unit 132 may carry out a (128-elements) dot product operation between FP16 input vector and FP16 K or V vector cached in one or more RAMs, e.g., every cycle. The dot product operation can be performed using the one or more multipliers and one or more tree adders in the RAM multiply add unit 132. A multiplier may multiple two values, such as two floating-point values. In an example, the attention dot unit 131 one or more FP16/FP16 multipliers. A multiplier may be specifically designed to perform multiplication of data having predetermined representations (e.g., FP4, FP6, FP8, FP12, FP16, INT8, etc.). One or more multipliers in the attention dot unit 131 may receive data from one or more RAMs. One or more tree adders may add multiplication results produced by one or more multipliers together.

The RAMs can store and provide data to one or more circuits performing logic operations in the RAM multiply add units 132. In some embodiments, a RAM multiply add unit 132 may receive an input number and multiplies it by a number from the RAM of the RAM multiply add unit 132 in every clock cycle. In some embodiments, a RAM may be a sequential read/write memory, such as a sequential read/write static random-access memory (SRAM). A sequential read/write memory can be used with or in an attention dot unit to supply weights to a multiplier in the RAM multiply add unit 132. A RAM that can be read sequentially or written sequentially may have drastically simplified logic and circuitry for reads or writes. The RAM may be used in a special configuration where it is not dynamically readable but is built up sequentially to reduce power and area.

In some embodiments, a RAM of a RAM multiply add unit 132 may be placed in proximity to the circuits performing logic operations in the RAM multiply add unit 132. The RAM may store intermediate values of the DNN. The intermediate values may be dynamic during the DNN inference, meaning their values may change. For instance, the RAM may store a key-value (KV) cache. New keys or values may be written into the RAM as they are generated. The RAM may be referred to as KV RAM. In embodiments where the RAM is a SRAM, it may be referred to as a KV SRAM. KV RAM can enable storing the attention history (e.g., cached keys and values) of a transformer block. In an exemplary implementation, 64 SRAMs may be used to store the 32 layers and K vs. V separately, so the SRAM can read lines sequentially.

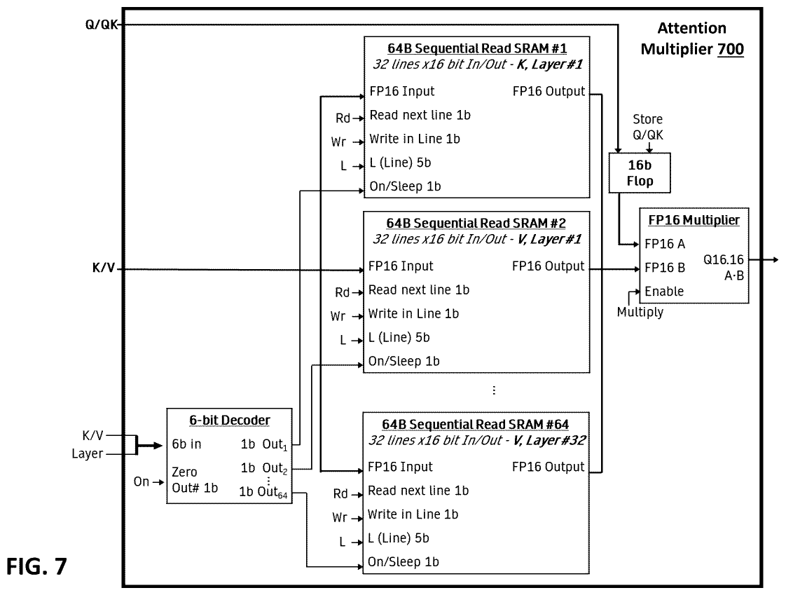

The tree adders in the RAM multiply add units 132 may add multiplication results produced by the multipliers together. A tree adder may also be referred to as an adder tree and may include adders arranged in a tree structure. The add unit 133 may add outputs of the RAM multiply add units 132. Certain aspects of the attention dot unit 131 are described below in conjunction with FIG. 7.

The IC device 100 uses a combination of ROM (e.g., sequential ROM) and RAM (e.g., sequential RAM) multiply add units, each optimized for different tasks (embedding and attention), with a base die handling core computations and activations. The use of die stacking technology can provide high memory density and efficient computation. By embedding the DNN's weights and architecture directly onto these specialized hardware sections described above, the need to repeatedly load weights onto a general-purpose GPU can be eliminated, significantly reducing latency and power usage. This innovative solution can address the problem of input context size limitations, cost, high power consumption, and time delays in AI inference. Furthermore, by dividing the system into specialized sections, each part can be optimized for its specific task. This can lead to faster and more efficient computations.

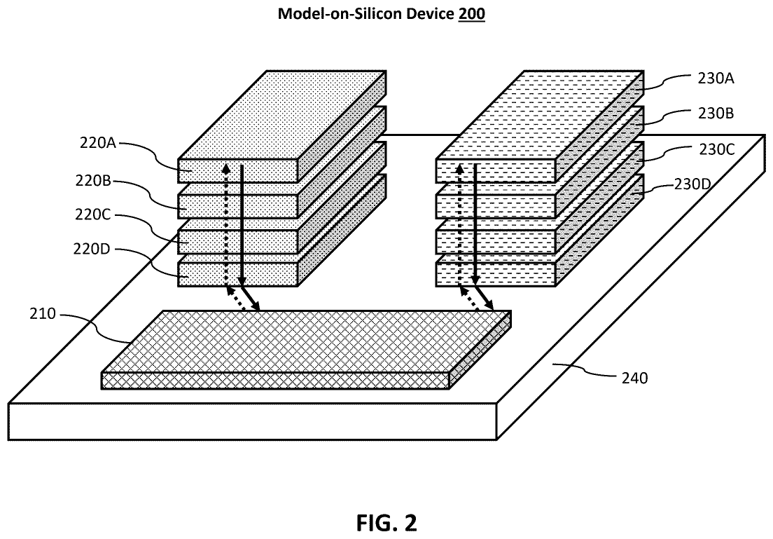

FIG. 2 illustrates a model-on-silicon device 200 with dies, in accordance with various embodiments. In some embodiments, a die may be a repeating unit of a semiconductor product that includes any suitable IC. A die may include one or more diodes, one or more transistors, other types of IC components, or some combination thereof. The model-on-silicon device 200 may implement a DNN model. For instance, the model architecture of the DNN may be mapped to various components of the model-on-silicon device 200. Internal parameters (e.g., weights) of the DNN may be stored in memories inside the model-on-silicon device 200. The model-on-silicon device 200 is an example of the IC device 100 in FIG. 1. As shown in FIG. 2, the model-on-silicon device 200 has nine dies, including a die 210, dies 220A-220D (collectively referred to as “dies 220” or “die 220”), and dies 230A-230D (collectively referred to as “dies 230” or “die 230”), which are arranged over a support structure 240. In other embodiments, the model-on-silicon device 200 may include fewer or more dies. Further, the arrangement of the dies in the model-on-silicon device 200 may be different.

The die 210, dies 220, and dies 230 may include hardware implementations of the operators and weights of the DNN. Each die (e.g., die 210, 220, or 230) may include circuitry to perform its unique computational tasks. In an exemplary implementation, the die 210 coordinates the overall operation of the DNN, handling preprocessing, embedding, normalization, activation, and final output generation. The die 210 may include circuitry to perform computations in the DNN, such as computations other than embedding computations and attention computations. The die 210 may also include circuitry to control the timing sequences of operations by the other components of the model-on-silicon device 200. Each die 220 may include circuitry to perform embedding computations in the DNN. Each die 230 may include circuitry to perform attention computations in the DNN. In some embodiments, the die 210 is an example of the base die 110 in FIG. 1, the dies 220 may be examples of the embedding dies 120 in FIG. 1, and the dies 230 may be examples of the attention dies 130 in FIG. 1. The use of stacked dies can allow for a compact and efficient design where memory-intensive operations (embedding and attention) are performed on separate dies. This separation can ensure that each type of computation is optimized for its specific requirements, improving overall performance and efficiency.

As shown in FIG. 2, the dies 220 are stacked over each other. Also, the dies 230 are stacked over each. The dies 220 (or dies 230) may be stacked using wafer bonding techniques, which may mirror the construction of memory chips. Each die 220 (or die 230) may be bonded to its adjacent die(s) 220 (or die(s) 230). The bonding may be hybrid bonding that combines electrical bonding (e.g., metal bonding) and dielectric bonding. The hybrid bonding can create both electrical connections and insulation between the bonded dies. The electrical connections may be facilitated using one or more bumps, such as micro-bumps. The electrical connections can enable interconnections among the die 210, dies 220, and dies 230. In an exemplary implementation, the die 210, dies 220, and dies 230 are interconnected through one or more fabrics. The interconnections among the die 210, dies 220, and dies 230 may be based on the EMIB technology.

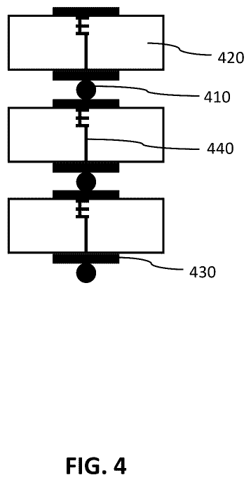

In some embodiments, the interconnections among the die 210, dies 220, and dies 230 may constitute data transfer paths along which data can be transferred among the die 210, dies 220, and dies 230. The data transfer paths are represented by the arrows in FIG. 2. In some embodiments, the die 210 may send data to the dies 220 or 230, such as data for flow control or input data for embedding or attention computations in the DNN. The dies 220 or 230 may send data to the die 210, such as data for performing other computations in the DNN. In an example, a data transfer path between the 210 with the die 220A may go through the dies 220B-220D, a data transfer path between the 210 with the die 220B may go through the die 220C and die 220D, and a data transfer path between the 210 with the die 220C may go through the die 220D. Similarly, a data transfer path between the 210 with the die 230A may go through the dies 230B-230D, a data transfer path between the 210 with the die 230B may go through the die 230C and die 230D, and a data transfer path between the 210 with the die 230C may go through the die 230D. Certain aspects regarding die-to-die bonding and interconnections are described below in conjunction with FIG. 4.

The support structure 240 may be a substrate. In some embodiments, the model-on-silicon device 200 is an IC package, and the support structure 240 is a package substrate. The support structure 240 may be formed of a dielectric material (e.g., a ceramic, a glass, a combination of organic and inorganic materials, a buildup film, an epoxy film having filler particles therein, etc., and may have embedded portions having different materials). The support structure 240 may also include one or more conductive pathways extending through the dielectric material. The one or more conductive pathways may allow circuitry within the dies to communicate with each other.

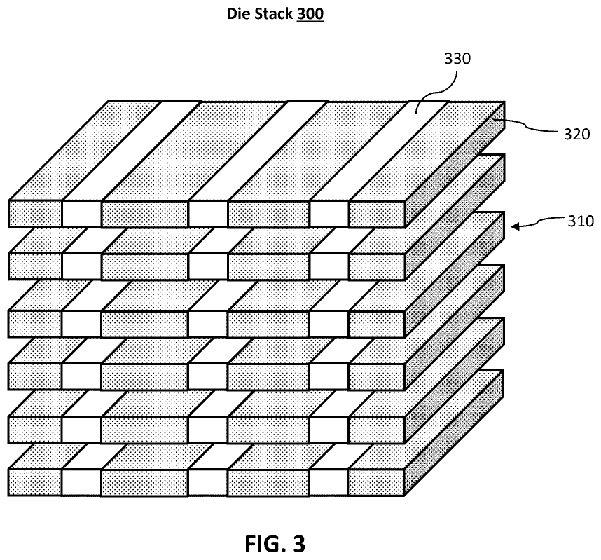

FIG. 3 illustrates a stack of dies with memory and compute components, in accordance with various embodiments. For the purpose of illustration, FIG. 3 shows a die stack 300 that includes a plurality of dies 310 (individually referred to as “die 310”). Each die 310 includes four memory sections 320 (individually referred to as “memory section 320”) and three compute sections 330 (individually referred to as “compute section 330”). The die stack 300 may be stacked embedding dies (such as the embedding dies 120 in FIG. 1) or stacked attention dies (such as the attention dies 130 in FIG. 1). In the embodiments of FIG. 3, the compute and model functions are handled in separate sections, aligning with the innovative architecture in this disclosure.

In some embodiments (e.g., embodiments where the die stack 300 is a stack of embedding dies), the memory sections 320 may include ROMs or RAMs (such as sequential ROMs or RAMs), while the compute sections 330 may include multipliers and adders. The memory sections 320 may store precomputed embedding vectors, such as weight vectors. These embedding vectors may be static. The compute sections 330 may perform multiplication operations on embeddings using the multipliers and sum the results of the multiplication operations using the adders.

In other embodiments (e.g., embodiments where the die stack 300 is a stack of attention dies), the memory sections 320 may include RAMs (such as sequential RAMs), while the compute sections 330 may include multipliers and adders. The memory sections 320 may provide high-speed storage for intermediate values. The intermediate values may be dynamic. Examples of the intermediate values include KV values. The compute sections 330 may perform multiplication operations required for attention mechanisms using the multipliers and sum the results of the attention multiplications using the adders to compute attention scores.

In some embodiments, each die 310 is interconnected, forming a cohesive computational unit. This design can allow computations to occur within the die 310 and ensure that the output from the die stack 300 has low bandwidth, effectively reducing or even eliminating the risk of data bottlenecks. This strategic separation and optimization of each section according to its specific computational needs can significantly enhance the overall performance and efficiency of the DNN.

The stacking of the dies 310 can provide a boost in memory capacity and efficient data access, thereby further optimizing the performance of these crucial components. The stacking can be beneficial for performing the embedding and attention computations in the DNN, as these computations can demand less compute power but require more memory. The stacked design can ensure that embedding and attention operations can leverage high memory and low latency. These factors can be critical for effectively managing large-scale models. Unlike the monolithic die approach, which can be restrictive in terms of scalability and flexibility, this stacked die design can offer more room for expansion and adaptability to future needs. This configuration can enhance processing speed, power efficiency, and overall performance in AI tasks.

FIG. 4 illustrates bumps 410 that provide electrical connections between stacked dies, in accordance with various embodiments. For the purpose of illustration, FIG. 4 shows three dies 420 (individually referred to as “die 420”) that are stacked. The three dies 420 may be examples of the embedding dies 120 in FIG. 1, attention dies 130 in FIG. 1, dies 220 in FIG. 2, dies 230 in FIG. 2, or die 310 in FIG. 3. FIG. 4 also shows a plurality of pads 430 (individually referred to as “pad 430”). Each die 420 is between a pair of pads 430, which are connected through a conductive pathway 440 (plurally referred to as “conductive pathways 440”). A conductive pathway 440 may include a through-silicon via (TSV). Each bump 410 is between two dies 420 and are connected to a pad 430 of each of the two dies 420.

The bumps 410 can provide electrical connections between the dies 420, facilitating inter-die communication. With the bumps 410, pads 430, and conductive pathways 440 forms a conductive path among the dies 420. Data (e.g., computational results) may be efficiently transferred between the dies 420 through the conductive path. The conductive path can also facilitate data being transferred to or from another die. Even though FIG. 4 shows a single bump 410 under each die 420. There may be a plurality of micro-bumps under each die 420. to create high-density interconnect.

In some embodiments, the bumps 410 are micro-bumps. The size of each bump 410 may be in the micrometer range. For instance, the bumps 410 may be as small as approximately 25-45 micrometers. Micro-bumps may be small metal connectors that can enable high-density, localized interconnection between different dies within a single package. In some embodiments, the bumps 410 may be formed through an EMIB process. The conductive path may be an EMIB path, such as an EMIB fabric. The EMIB fabric can provide a high-bandwidth, low-latency interconnect between dies, enabling efficient communication and data transfer. Therefore, the EMIB path can ensure high-speed communication and low-latency data transfer, enabling seamless integration and coordination of the different computational tasks.

FIG. 5 illustrates an embedding dot unit 500, in accordance with various embodiments. The embedding dot unit 500 may be a hardware implementation of embedding computations in a DNN model. The embedding dot unit 500 may be part of an embedding die, such as the embedding die 120 in FIG. 1. The embedding dot unit 500 may be an example of the embedding dot unit 121 in FIG. 1.

As shown in FIG. 5, the embedding dot unit 500 includes a multiplier unit 510, an adder unit 520, and a sampler 530. In other embodiments, the embedding dot unit 500 may include fewer, more, or different components. The multiplier unit 510 may perform elements dot product operation between an embedding vector (e.g., FP8 embedding vector) and a weights vector (e.g., FP6 weights vector read from sequential ROM) every cycle. The multiplier unit 510 includes a plurality of weights multipliers. In an example of FIG. 5, the embedding dot unit 500 may include 4,096 weights multipliers: weights multiplier #1 through weights multiplier #4,096. The weights multipliers may perform multiplication in parallel. The outputs (e.g., 4096 outputs) may be added together by the adder unit 520.

In the example of FIG. 5, the adder unit 520 includes 4,095 adders. These adders are arranged in a tree or hierarchical structures. In some embodiments, the adder unit 520 may use a special fixed-point adder with a relatively large number of bits (e.g., 20 bits, 21 bits, . . . 32 bits). The 4,095 adders may be arranged in 5 tiers. A tier is a level in the tree structure. The first tier includes 2,048 adders, for instance. Each adder in the first tier sums two products from two weights multipliers, respectively. Each adder in the second tier sums the outputs of two adders in the first tier. Each adder in the third tier sums the outputs of two adders in the second tier. This continues till adder #4095 is reached. The adder in the 5th tier outputs the final sum, which may be a 33-bit number, which is then provided to the sampler 530. The sampler 530 may be a FP16 sampler. The sampler 530 may resample the final sum into a floating-point representation. The embedding dot unit 500 may generate an FP16 output. Using a large number of bits in the adder unit 520 can prevent overflow during many stages/layers of adding.

FIG. 6 illustrates a sequential ROM 600, in accordance with various embodiments. Sequence read-only memory is a type of memory storage, utilizing ROMs, that allows data to be read sequentially but not written or modified after the values have been etched onto the ROM. The rest of the ROM can be shut down to reduce power and area. In some embodiments, the sequential ROM 600 may be a ROM in an embedding die, such as the embedding die 120 in FIG. 1.

For the purpose of illustration, the sequential ROM 600 in FIG. 6 has six word lines. The sequential ROM 600 can power up an active current word line and an active next word line at a time, while other word lines can be powered down. The active current word line refers to the word line having data being used or processed by a circuit to perform an operation during a time slot in the predetermined timing sequence. The active next word line refers to the word line having data being used or processed by the circuit to perform an operation during a further/next time slot in the predetermined timing sequence. The sequential ROM 600 can power down the rest of the word lines, or the rest of the word lines in the sequential ROM 600 can remain powered down. At the next clock or time slot, the active current word line is powered down, the active next word line is already powered up, and a further active next word line is powered up. At every clock or time slot, two word lines may be powered up in the sequential ROM 600. The two active word lines that are powered up may get moved by one word line down the sequential ROM at every clock or time slot.

In some embodiments, one or more sequential ROMs may be provided on the chip to store various weight matrices for a transformer model:

| Num. Lines | Layer | Matrix |
|---|---|---|
| 16 | 0 | W_{Q} |
| 4 | 0 | W_{K} |
| 4 | 0 | W_{V} |
| 16 | 0 | W_{O} |
| 112 | 0 | W₁ |
| 56 | 0 | W₂ |
| . . . | . . . | . . . |
| 16 | 31 | W_{Q} |
| 4 | 31 | W_{K} |
| 4 | 31 | W_{V} |
| 16 | 31 | W_{O} |
| 112 | 31 | W₁ |
| 56 | 31 | W₂ |
| 16 | 31 | W_{Q} |
| 501 | — | W_{cls} |

In some embodiments, an IC device implementing a DNN may have 1,048,576 ROMs (e.g., sequential ROMs) for storing weights. A ROM may hold weights in FP6 format. A ROM output may be a 6-bit value. A weights ROM may hold a specific weight matrix column, since a weights ROM can output a single number out of the 4096-element vector being multiplied in the EDU. A weights ROM may hold one of 256 weight matrix rows, e.g., when there are 256 embedding dot units working in parallel and producing 256 numbers per clock cycle. A ROM may hold matrix rows 1, 257, . . . , and another ROM can hold matrix rows 2, 258, and so forth. In some cases, a weights ROM may hold elements from (all) weights matrices in (all) layers, since a weights ROM sequentially outputs the number the matrix multiplier is using for (all) transformers and matrices, as the weights multipliers are shared across all layers and weights matrices. The weights ROM may hold (only) the linear layers' weights. There may be one or more dedicated ROMs for the embedder unit and layer normalizer unit.

FIG. 7 illustrates an attention multiplier unit 700 with a sequential read/write memory, in accordance with various embodiments. The attention multiplier unit 700 may be a hardware implementation of attention multiplication operations in a DNN. The attention multiplier unit 700 may be part of an attention die, such as the attention die 130 in FIG. 1.

In the embodiments of FIG. 7, the attention multiplier unit 700 includes sequential read/write memories. A sequential read/write memory may involve using an SRAM in a special configuration that it is not dynamically readable but is built up sequentially to reduce power and area. As shown in FIG. 7, the sequential read/write memories in the attention multiplier unit 700 are sequential read SRAMs. An SRAM that can be read sequentially or written sequentially has drastically simplified logic and circuitry for reads or writes. A sequential read/write memory can be used with or in an attention dot unit to supply weights to the attention multiplier unit 700. In one implementation, the attention dot unit having the attention multiplier unit 700 may receive an input number and multiplies it by a number from SRAM (e.g., sequential read/write memory) every clock cycle. 64 SRAMs may be used to store the 32 layers and K vs. V separately, so the SRAM can read lines sequentially.

According to one aspect, the sequential read/write memory may be referred to as key-value Static Random-Access Memory (KV SRAM), which can store data in key-value pairs. KV SRAM can enable storing the attention history (e.g., cached keys and values) of a transformer block. In some embodiments, the attention dot unit may receive an input number and multiplies it by a number from SRAM in every clock cycle. 64 SRAMs are used to store the 32 layers and K vs. V separately, so the SRAM can read lines sequentially.

In some embodiments, a sequential read/write memory may store a KV cache for the DNN. To improve computational efficiency, one or more KV caches can be included on chip with the additional dot unit(s) to enhance the performance of the model by temporarily storing frequently accessed data. Keys and values computed in the attention mechanism can be cached to allow for rapid retrieval of information. In some embodiments, the key may represent a unique identifier for a specific input or query, while the value may include the corresponding output or computational result. This caching mechanism deals with dynamic data, and thus uses read/write memory, such as SRAM. The KV cache can significantly reduce latency and computational overhead by avoiding redundant calculations and data fetching, thereby improving the efficiency and responsiveness of the model during inference. Because the cached keys and values can be written and read sequentially during inference, the SRAM implementation can be simplified by restricting reads and writes to be done in a sequential manner (obviating circuits that allow for random-access).

In some embodiments, the queries, keys, or values may be FP16 values. The attention multiplier unit 700 may receive a K/V control signal, layer control signal, SRAM read control signal, SRAM write control signal, SRAM line to write control signal, store Q/QK control signal, on/sleep control signal, other types of control signals, or some combination thereof. The attention multiplier unit 700 may operate under the control signals. For instance, the decoder may turn on one of the 64 SRAMs based on the layer control signal (which may indicate which layer is being executed) and K/V control signal (which may indicate whether to multiply K or V). A control signal may have 1 bit. In an example where there are 16 attention dot units per head, 32 lines may be used. The output of the attention multiplier unit 700 may be 32-bit numbers, such as 32-bit fixed-point so adders can use it. In some embodiments, there may be 65,536 instances of the attention multiplier unit 700 in the IC device. 65,536 equals 32 heads times 16 dots/heads times 128.

In some embodiments, the attention multiplier unit 700 is included in an attention dot unit to perform multiplication of two numbers (e.g., FP16 value and FP16 value), where one of the two numbers may be read from the sequential read/write memory storing the KV cache. As illustrated, the attention multiplier unit 700 includes 64 sequential read SRAMs, and a 6-bit decoder. The decoder may turn on one of the 64 sequential read SRAMs to be used. Data may be read from the active sequential read SRAM serially, e.g., line by line. The data the active sequential read SRAM may be multiplied against the input by the FP16 multiplier. Many instances of attention multiplier unit 700 may be included in an attention dot unit to perform elementwise multiplication, e.g., in parallel. The multiplication results of the instances of the attention multiplier unit 700 may be summed by a tree adder to form a vector dot product result. The attention dot unit may perform many vector dot products to form a final matrix multiplication result.

Certain aspects of hardware implementing models on silicon are further described in U.S. patent application Ser. No. 19/281,006, filed on Jul. 25, 2025, U.S. patent application Ser. No. 19/275,640, filed on Jul. 21, 2025, and U.S. patent application Ser. No. 19/244,318, filed on Jun. 20, 2025, each of which is hereby incorporated by reference in its entirety.

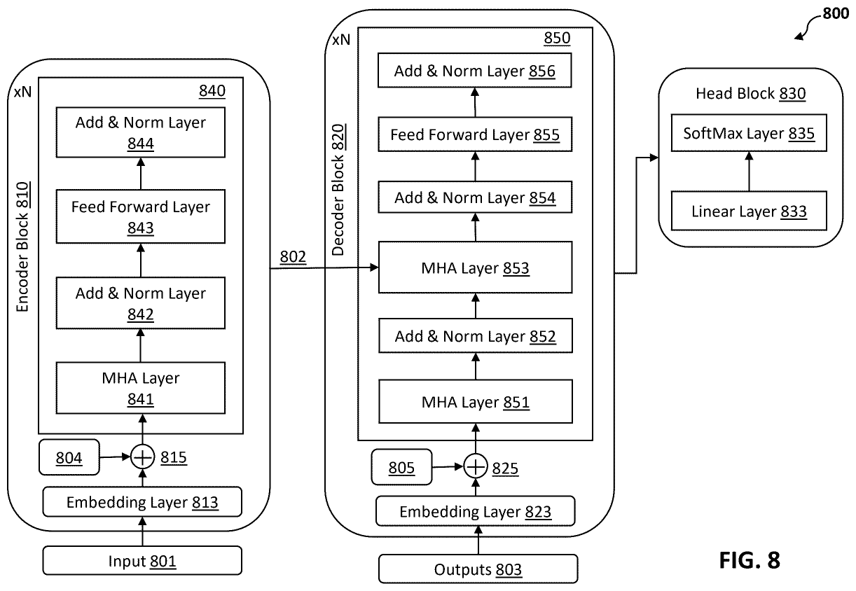

FIG. 8 illustrates an example transformer model 800, in accordance with various embodiments. The transformer model 800 is an example of the DNNs described above. The transformer model 800 may be embedded on a chip. An example of the chip is the IC device 100 in FIG. 1 or the model-on-silicon device 200 in FIG. 2. As shown in FIG. 8, the transformer model 800 includes an encoder block 810, a decoder block 820, and a head block 830. In other embodiment, different or additional components may be included in the transformer model 800. Further, functionality attributed to a component of the transformer model 800 may be accomplished by a different component included in the transformer model 800 or a different model or module.

The encoder block 810 receives input sequences and generates matrix representations of the input sequences. In the embodiments of FIG. 8, the encoder block 810 receives an input 801 and generates an encoder output 802. The input 801 may be an input prompt. In some embodiments, the input 801 may include one or more input tokens, such as words, phrases, sentences, images, audio signals, other types of input tokens, or some combination thereof. In an example, the input 801 may include a prompt received from a user of the transformer model 800. The prompt may include a question or request made by the user. A word in the prompt may be an input token. In some embodiments, the encoder output 802 may include one or more vectors that are contextualized representations of the input 801. Each vector in the encoder output 802 may represent a token in the input 801 with contextual understanding.

The encoder block 810 includes an embedding layer 813, a positional encoding layer 815, and a plurality of layers 840 (individually referred to as “layer 840”). In other embodiments, the encoder block 810 may have different, fewer, or more components. Also, the arrangement of the components in the encoder block 810 may be different from the arrangement shown in FIG. 8. For the purpose of illustration, the encoder block 810 has N layers in FIG. 8, where N is an integer. Each layer 840 may include one or more neural network operations. The layers 840 may transform a sequence of embeddings into a representation that encapsulates the learned information from the input 801. Different layers 840 may have different internal parameters, e.g., different weights, bias, or other types of internal parameters. In some embodiments, the layers 840 have identical components. The components in a layer 840 may be layers and may also be referred to as sub-layers of the layer 840. As shown in FIG. 8, a layer 840 includes four sub-layers: a multi-head attention (MHA) layer 841, an add & norm layer 842, a feed forward layer 843, and another add & norm layer 844.

The decoder block 820 iteratively generates outputs 803 using encoded representations generated by the encoder block 810. The decoder block 820 includes an embedding layer 823, a positional encoding layer 825, and a plurality of layers 850 (individually referred to as “layer 850”). For the purpose of illustration, the decoder block 820 has N layers in FIG. 8, where N is an integer. In the embodiments of FIG. 2, the number of layers 850 in the decoder block 820 is the same as the number of layers 840 in the encoder block 810. In other embodiments, the number of layers 850 in the decoder block 820 may be different from the number of layers 840 in the encoder block 810. Each layer 850 may include one or more neural network operations. Different layers 850 may have different internal parameters. In some embodiments, the layers 850 may have identical components. The components in a layer 850 may be layers and may also be referred to as sub-layers of the layer 850. As shown in FIG. 8, a layer 850 includes six sub-layers: an MHA layer 851, an add & norm layer 852, another MHA layer 853, another add & norm layer 854, a feed forward layer 855, and another add & norm layer 856.

In some embodiments, a sequence of inference stages is performed in the decoder block 820 using encoder outputs, e.g., the encoder output 802. A matrix may be predicted through each inference stage. The outputs 803 may include a plurality of matrices. Each matrix may be further processed in the head block 830 to predict a token. The plurality of matrices may be used to predict a sequence of tokens. For the first inference stage, the decoder block 820 may receive one or more start tokens as input tokens and compute a first matrix from the input tokens and the output of the encoder block 810. The first matrix may be used by the head block 830 to predict a first token. The predicted token may be used as a new input token, in addition to the start token(s), in the second inference stage. Similarly, a second token may be predicted through the second inference stage and may be used in the third inference stage. This iteration may continue till all the inference stages are complete.

The head block 830 receives the output of the decoder block 820 and processes it in a linear layer 833 and a SoftMax layer 835. A linear operation may be performed on the output of the decoder block 820 in the linear layer 833. The linear operation may include a multiplication of the output of the decoder block 820 with a weight matrix. The output of the linear layer 833 may be a vector. In some embodiments, the head block 830 may function as a classifier. The number of data elements in the vector computed in the linear layer 833 may depend on the number of classes involved. In an example where there are M classes, where M is an integer, the vector computed in the linear layer 833 may have M data elements representing the prediction for the M classes, respectively.

The output of the linear layer 833 may be input into the SoftMax layer 835. A SoftMax function may be applied on the output of the linear layer 833 to compute probability scores. A probability score may have a value in the range from 0 to 8. In some embodiments, a probability value is computed for each data element in the vector computed in the linear layer 833. The highest one of the probability scores may be the key. The corresponding index of the key may point to the token that the transformer model 800 predicts as the next in the sequence. The final output of the transformer model 800 may be the sequence of predicted tokens. In some embodiments, the head block 830 may be a language modeling head.

An embedding layer (e.g., the embedding layer 813 or the embedding layer 823) converts an input of the embedding layer (e.g., the input 801 or the outputs 803) into one or more embeddings. An embedding may be a vector, which is also referred to as an embedding vector or a vector embedding. The vector embedding may include a sequence of data elements. In some embodiments, the embedding layer 813 may generate a plurality of embeddings, each of which may be converted from a different input token in the input 801. The embeddings may capture the semantic meaning of the tokens in the input 801. The embeddings may be numerical representations that capture the relationships or meanings of words, phrases, or other data types. In an example where the input 801 is a prompt including a sequence of words, the embedding layer 813 may generate an embedding from each word in the input 801. The embedding layer 823 in the decoder block 820 may generate a plurality of embeddings from tokens received by the decoder block 820 in a similar manner as the embedding layer 813.

A positional encoding layer (e.g., the positional encoding layer 815 or the positional encoding layer 825) performs positional encoding on embeddings generated in the corresponding embedding layer. In some embodiments, the positional encoding layer may apply one or more positional encoding vectors (e.g., a positional encoding vector 804 or positional encoding vector 805) on vector embeddings from the corresponding embedding layer to generate new vector embeddings that represent the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer.

An MHA layer (e.g., the MHA layer 841, the MHA layer 851, or the MHA layer 853) may implement a multi-head attention mechanism, which may be a multi-head self-attention mechanism or a multi-head cross-attention mechanism. In some embodiments, the MHA layer 841 or the MHA layer 851 may implement a self-attention mechanism. For self-attention, the queries, keys, and values may come from the same place. For instance, for the MHA layer 841, the queries, keys, and values may all come from the positional encoding layer 815. For the MHA layer 851, the queries, keys, and values may all come from the positional encoding layer 825. The self-attention mechanism may enable the transformer model 800 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 841 may be computed from vector embeddings generated by the positional encoding layer 815. The queries, keys, and values input into the MHA layer 851 may be computed from vector embeddings generated by the positional encoding layer 825. A query, key, or value may be a vector the represents a token in a sequence. In some embodiments, a query matrix Q∈ [symbol] may be computed by multiply an embedding matrix X∈ [symbol] (e.g., an embedding matrix computed in a positional encoding layer) with a weight matrix W_{q} ∈ [symbol] , where d is the dimension of a vector embedding, N is the number of vector embeddings in the embedding matrix, and h is the number of attention heads. Each row in the query matrix may be a query. A key matrix K∈ [symbol] may be computed by multiple an embedding matrix X∈ [symbol] (e.g., an embedding matrix computed in a positional encoding layer) with a weight matrix Wₖ∈ [symbol] . Each row in the key matrix may be a key. A value matrix V∈ [symbol] may be computed by multiple an embedding matrix X∈ [symbol] (e.g., an embedding matrix computed in a positional encoding layer) with a weight matrix Wᵥ∈ [symbol] . Each row in the value matrix may be a value.

In some embodiments, the MHA layer 851 may implement masked multi-head self-attention. The MHA layer 851 may prevent positions from attending to subsequent positions. For instance, each token in the sequence may not be influenced by future tokens. This masking can ensure that the predictions of a particular position can depend on known outputs at positions before it and not depend on unknown outputs at positions after it.

In some embodiments, the MHA layer 853 may implement a cross-attention mechanism, such as encoder-decoder cross-attention. The MHA layer 853 may use outputs from the previous layer (i.e., the add & norm layer 852) as queries and use outputs from the encoder block 810 as keys and values. The cross-attention can align the encoder's input with the decoder's, empowering the decoder block 820 to identify and emphasize the most relevant parts of the encoder's input.

In some embodiments, an MHA layer includes linear layers, a MatMul layer, a scale layer, a SoftMax layer, another MatMul layer, a concatenation layer, and another linear layer. These layers may be arranged in a sequence. The MHA layer may receive three input matrices: a query matrix, a key matrix, and a value matrix, which are inputs of three linear layers, respectively. The linear layers may include matrix multiplication (MatMul) operations. For instance, a first linear layer may perform a multiplication of the query matrix with a weight matrix to compute a first parameter matrix. The first parameter matrix may be denoted as

$${QW}_{i}^{Q} ,$$

where Q is the query matrix and

$${W}_{i}^{Q}$$

∈ [symbol] is the weight matrix. A second linear layer may perform a multiplication of the key matrix with a weight matrix to compute a second parameter matrix. The second parameter matrix may be denoted as

$${KW}_{i}^{K} ,$$

where K is the key matrix and Wᵢ^{K}∈ [symbol] is the weight matrix. A third linear layer may perform a multiplication of the value matrix with a weight matrix to compute a third parameter matrix. The third parameter matrix may be denoted as

$${VW}_{i}^{V} ,$$

where V is the value matrix and

$${W}_{i}^{V}$$

∈ [symbol]
RdmodelXdk is the weight matrix. i may indicate the index of the head. d_{q} is the dimension of a query vector. dₖ is the dimension of a key vector. dᵥ is the dimension of a value vector. In some embodiments, d_{q}=dₖ=dᵥ=d_{model}/h. In some embodiments, the linear layers may be in a linear block of the MHA layer. In some embodiments, the MHA layer may include multiple linear blocks. For instance, the MHA layer includes h linear blocks. The linear blocks may have the same layers as each other. Each linear block may compute three parameter matrices from the query matrix, key matrix, and value matrix, respectively.

The MatMul layer, scale layer, mask layer, SoftMax layer, and MatMul layer may be in an attention block of the MHA layer. The attention block may implement a scaled dot product attention mechanism. In some embodiments, the MHA layer includes a plurality of attention blocks that includes the attention block. For the purpose of illustration, the MHA layer includes h attention blocks. The attention blocks may have the same layers as each other. A linear block and an attention block may constitute a head of the MHA layer. When the MHA layer has h linear blocks and h attention blocks, the MHA layer has h heads. A head may be denoted as

$${head}_{i} = Attention ( {QW}_{i}^{Q} , {KW}_{i}^{K} , {VW}_{i}^{V} ) .$$

A matrix multiplication operation may be performed on parameter matrices in the MatMul layer, which computes a score matrix. In some embodiments, the score matrix may establish the degree of emphasis each token should place on other tokens. The score matrix may include a plurality of scores. Each token may be assigned a score in relation to other tokens within the same time step. A higher score may indicate a higher focus or emphasis. The score matrix may be scaled in the scale layer. In some embodiments, the score matrix is scaled down in the scale layer by dividing the scores in the score matrix by the square root of the dimension of the query vector and the key vector, which may be denoted as \sqrt{dₖ}. The output of the scale layer may be a scaled matrix, which includes adjusted scores. The mask layer may be optional in some embodiments. The mask layer may add an attention mask (which may be an input to the attention block) to the output of the scale layer to mask out some elements in the output of the scale layer. The positions of the masked-out elements may be defined by the attention mask. A SoftMax function may be applied on the scaled matrix in the SoftMax layer to compute an attention weight matrix. The attention weight matrix includes attention weights. The attention weights may be probability values ranging from 0 to 1. The SoftMax function may emphasize high scores while diminishing low scores, which can enhance the model's ability to determine which tokens should get more attention.

In the MatMul layer, a matrix multiplication operation is performed on the attention weight matrix computed in the SoftMax layer and the parameter matrix computed from value matrix in the corresponding linear layer. The result of the matrix multiplication operation is a single-head output matrix, which is an output of the attention block.

When the MHA layer has h attention blocks, there may be h single-head output matrices. The single-head output matrices are concatenated in the concatenation layer to form a concatenated matrix. A linear operation (also referred to as “linear transformation”) is performed on the concatenated matrix using a weight matrix in the linear layer. In some embodiments, the MHA may be denoted as MultiHead(Q, K, V)=Concat(head₁, head₂, . . . , headₕ)W^{O}, where Concat denotes concatenation, and W^{O}∈ [symbol] is the weight matrix in the corresponding linear layer.

An add & norm layer in the transformer model 800, such as the add & norm layer 842, 844, 852, 854, and 856, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 842 is the MHA layer 841. As another example, the preceding layer of the add & norm layer 854 is the MHA layer 853.

Then the layer normalization operation is applied on the result of the addition operation, which may be denoted as LayerNorm(x+sublayer(x)), where LayerNorm denotes layer normalization, x is the input of the preceding layer, and sublayer(x) denotes the output of the preceding layer. In some embodiments, the layer normalization operation may include a sequence of computations. In an example, the layer normalization operation may include a mean computation, which may be denoted as

$${μ}_{xy} = \frac{1}{Z} \times {\sum }_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−μ_{xyz}. The layer normalization operation may further include a variance computation denoted as

$${σ}_{x y}^{2} = {\sum }_{z = 1}^{Z} {D}_{x y z}^{2}$$

and a division computation denoted as

$${M}_{xy} = \frac{1}{\sqrt{\frac{1}{Z} \times ( {σ}_{xy}^{2} + ϵ \times Z )}}$$

M_{xy} may be a 2D tensor. The layer normalization operation may also convert M_{xy} to a 3D tensor M_{xyz}, e.g., by replicating every data element over z output points. Further, the layer normalization operation may have an element multiplication denoted as

$${{A}^{′}}_{xyz} = \frac{{A}_{xyz} - {μ}_{xyz}}{\sqrt{\frac{1}{Z} \times ( {σ}_{xy}^{2} + ϵ )}} = ( {A}_{xyz} - {μ}_{xyz} ) \times \frac{1}{\sqrt{\frac{1}{Z} \times ( {σ}_{xy}^{2} + ϵ )}} = {D}_{xyz} \times {M}_{xyz} .$$

The layer normalization operation may further compute

$${A}_{xyz}^{″} = {A}_{xyz}^{′} + \frac{{β}_{z}}{{γ}_{z}} and L {N}_{xyz} = {A}_{xyz}^{″} \times {γ}_{z} \cdot L {N}_{xyz}$$

may be the output of the layer normalization operation.

A feed forward layer (e.g., the feed forward layer 843 and the feed forward layer 855) may be a position-wise fully-connected feed forward network. In an example, the feed forward layer may include two linear layers with an activation function in between. An example of the activation function is Rectified Linear Unit (ReLU).

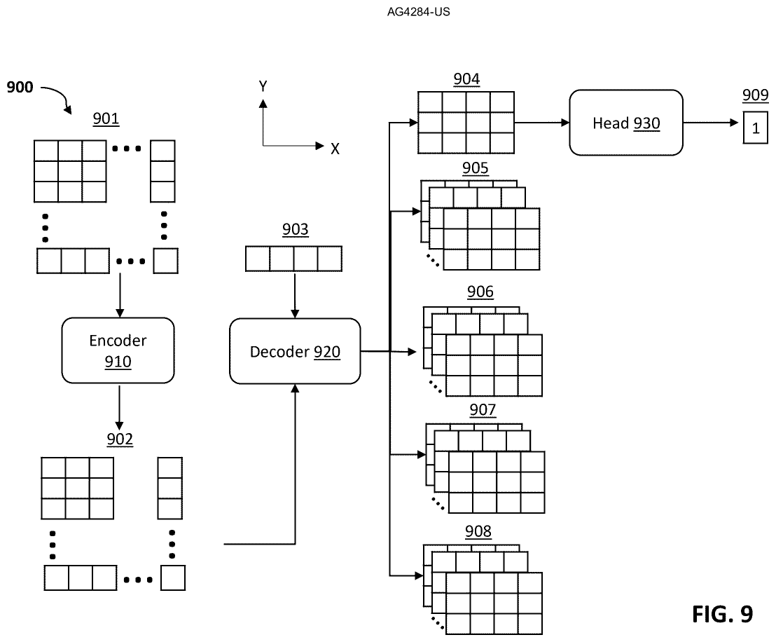

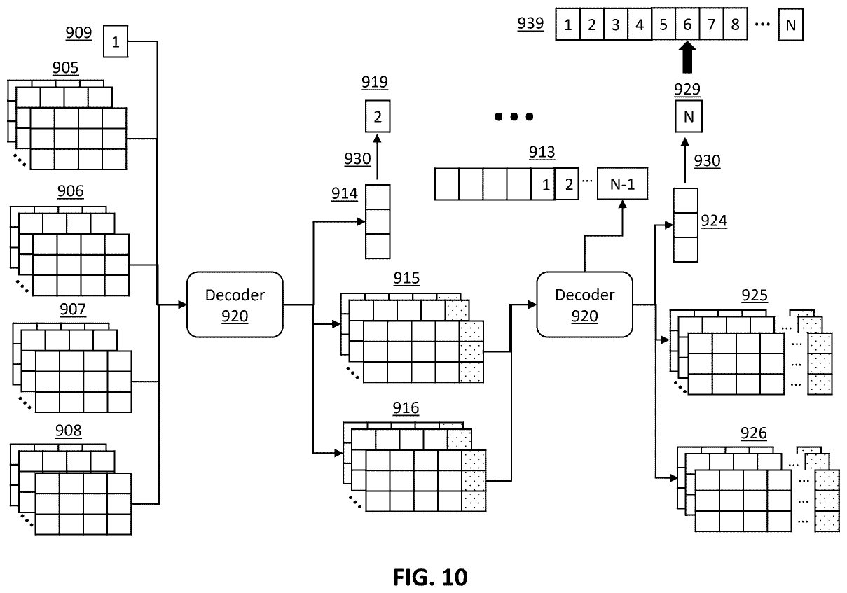

FIGS. 9 and 10 illustrate inferences of a transformer model 900, in accordance with various embodiments. FIG. 9 illustrates the first inference process of the transformer model 900, in accordance with various embodiments. The transformer model 900 includes an encoder 910, a decoder 920, and a head 930. An example of the transformer model 900 may be the transformer model 800 in FIG. 8. In the embodiments of FIG. 9, the encoder 910 receives an input tensor 901. The input tensor 901 may be a feature map extracted from one or more images, text documents, audio files, videos, other types of data, or some combination thereof. The encoder 910 generates an output tensor 902 from the input tensor 901. The shape of the output tensor 902 may be denoted as [batch size, SL_{encoder}, d_{model}], where SL_{encoder} may be the dimension along the X axis (i.e., the width of the output tensor 902), and d_{model} may be the dimension along the Y axis (i.e., the height of the output tensor 902). The encoder 910 may include a plurality of layers arranged in a sequence, such as the layers inside the encoder block 810 in FIG. 8. The output tensor 902 is provided to the decoder 920.

The decoder 920 receives the output tensor 902 and an input sequence 903. The input sequence 903 may be a sequence of tokens. A token may be a numerical representation of an input signal, such as word, image, audio signal, video signal, etc. The dimension of the input sequence 903, which may be denoted as SLᵢₙₚᵤₜ, may be the total number of tokens in the input sequence 903. For the purpose of illustration and simplicity, SLᵢₙₚᵤₜ is 4. In other embodiments, the input sequence 903 may have a different shape. For instance, the input sequence 903 may be a 2D tensor. The dimension of the 2D tensor along the X axis may be SLᵢₙₚᵤₜ, while the dimension of the 2D tensor along the Y axis may be a batch size indicating the number of batches in the input sequence 903.

The decoder 920 computes an output tensor 904, a self-attention key tensor 905, a self-attention value tensor 906, a cross-attention key tensor 907, and a cross-attention value tensor 908. In some embodiments, the shape of the output tensor 904 may be denoted as [batch size, SLᵢₙₚᵤₜ, d_{model}]. The shape of the self-attention key tensor 905 or the shape of the self-attention value tensor 906 may be denoted as N×[batch size, h, SLᵢₙₚᵤₜ, d_{head}], where N is the number of identical layers in the decoder (e.g., the number of layers 850 in the decoder block 820), h is the total number of heads in a MHA layer, and d_{head} is the dimension of a query vector, key vector, or value vector. In some embodiments, d_{model}=h×d_{head}. The shape of the cross-attention key tensor 907 or the shape of the cross-attention value tensor 908 may be denoted as N×[batch size, h, SL_{encoder}, d_{head}].

The output tensor 904 may be provided to the head 930 and the head 930 outputs a predicted token 909. The shape of the token 909 may be denoted as [batch size, 1]. For the purpose of illustration and simplicity, batch size is 1 in FIG. 9. In other embodiments, batch size may be a larger number. The predicted token 909 may be stored in a buffer. In some embodiments, the predicted token 909 may be used to update the input sequence 903. For instance, the predicted token 909 may be added to the right of the input sequence 903. The updated input sequence may be used as the input sequence in the second inference phase. In the second inference phase, the decoder 920 may receive the updated input sequence and the output tensor 902 for predicting another token. The output tensor 902 may remain the same during inference of the decoder 920. Certain aspects of subsequent inference processes are described below in conjunction with FIG. 10.

In some embodiments, the self-attention key tensor 905 and the self-attention value tensor 906 may be provided to a self-attention layer in the decoder 920, an example of such a self-attention layer is the MHA layer 151. The self-attention key tensor 905 may be stored in a self-attention key cache. The self-attention key cache may have the same shape as the self-attention key tensor 905. The self-attention value tensor 906 may be stored in a self-attention value cache. The self-attention value cache may have the same shape as the self-attention value tensor 906.

In some embodiments, the decoder 920 computes the self-attention key tensor 905 and the self-attention value tensor 906 from the input sequence 903. The input sequence 903 may be dynamic during inference of the decoder 920. For instance, a new token may be added to the input sequence 903 after each inference phase, as described above. As the input sequence 903 changes, the self-attention key tensor 905 and the self-attention value tensor 906 would also change. For instance, the dimension of the self-attention key tensor 905 or the self-attention value tensor 906 along the X axis may increase as SLᵢₙₚᵤₜ increases. The self-attention key cache and the self-attention value cache may change during all the inference phases of the decoder 920 to accommodate the changes in the self-attention key tensor 905 and the self-attention value tensor 906.

In some embodiments, the cross-attention key tensor 907 and the cross-attention value tensor 906 may be provided to a cross-attention layer in the decoder 920, an example of such a cross-attention layer is the MHA layer 153. The cross-attention key tensor 907 may be stored in a cross-attention key cache. The cross-attention key cache may have the same shape as the cross-attention key tensor 907. The cross-attention value tensor 908 may be stored in a cross-attention value cache. The cross-attention value cache may have the same shape as the cross-attention value tensor 908. In some embodiments, the decoder 920 computes the cross-attention key tensor 907 and the cross-attention value tensor 906 from the output tensor 902 generated in the encoder 910. As the output tensor 902 does not change during inference of the decoder 920, the cross-attention key tensor 907 and the cross-attention value tensor 906 may remain the same during all the inference phases of the decoder 920. The cross-attention key cache and the cross-attention value cache may remain the same during all the inference phases of the decoder 920.

FIG. 10 illustrates subsequent inference processes of the transformer model 900, in accordance with various embodiments. In the second inference phase, the decoder 920 may reuse the self-attention key tensor 905, self-attention value tensor 906, cross-attention key tensor 907, and cross-attention value tensor 908. The decoder 920 also receives the predicted token 909. The decoder 920 may compute self-attention key vectors from the predicted token 909 and concatenate the self-attention key vectors with the self-attention key tensor 905 to generate a new self-attention key tensor 915. For instance, a self-attention key vector for each head may be added to the right of a self-attention key matrix in the self-attention key tensor 905, and the self-attention key vector and the self-attention key matrix may correspond to the same head. The elements highlighted with a dot pattern in the self-attention key tensor 915 are the self-attention key vectors generated from the predicted token 909.

Similarly, the decoder 920 may compute self-attention value vectors from the predicted token 909 and concatenate the self-attention value vectors with the self-attention value tensor 906 to generate a new self-attention value tensor 916. For instance, a self-attention value vector for each head may be added to the right of a self-attention value matrix in the self-attention value tensor 906, and the self-attention value vector and the self-attention value matrix may correspond to the same head. The elements highlighted with a dot pattern in the self-attention value tensor 916 are the self-attention value vectors generated from the predicted token 909.

The decoder 920 also generates an output tensor 914. The decoder 920 may generate the output tensor 914 using the new self-attention key tensor 915 and new self-attention value tensor 916. The output tensor 914 is used by the head 930 to generate another predicted token 919. The predicted token 919 is the output of the transformer model 900 in the second inference phase.

One or more other subsequent inference processes may be conducted. In each subsequent inference phase, the decoder 920 receives a token predicted in the previous inference phase, a self-attention key tensor generated in the previous inference phase, a self-attention value tensor generated in the previous inference phase, the cross-attention key tensor 907, and the cross-attention value tensor 908. The decoder 920 may, in the subsequent inference phase, generate a larger self-attention key tensor and a larger self-attention value tensor, in addition to an output tensor which can be used by the head 930 to predict a new token.

In embodiments where the total number of inference phases is N, the input sequence 903 is updated to an input sequence 913 after N−1 inference phases. In the last inference phase (i.e., the Nth inference phase), the decoder 920 may receive the predicted token generated in the (N−1)th inference phase, the self-attention key tensor generated in the (N−1)th inference phase, the self-attention value tensor generated in the (N−1)th inference phase, the cross-attention key tensor 907, and the cross-attention value tensor 908. The decoder 920 may generate a self-attention key tensor 925 and a self-attention value tensor 926 using the predicted token generated in the (N−1)th inference phase, the self-attention key tensor generated in the (N−1)th inference phase, and the self-attention value tensor generated in the (N−1)th inference phase. The dimensions of the self-attention key tensor 925 or self-attention value tensor 926 along the X axis is SLᵢₙₚᵤₜ+N. The decoder 920 also generates an output tensor 924, which is used by the head 930 to generate the last predicted token 929. The N tokens predicted by the transformer model in the N inference phases may constitute an output tensor 939, which may be the final output of the transformer model.

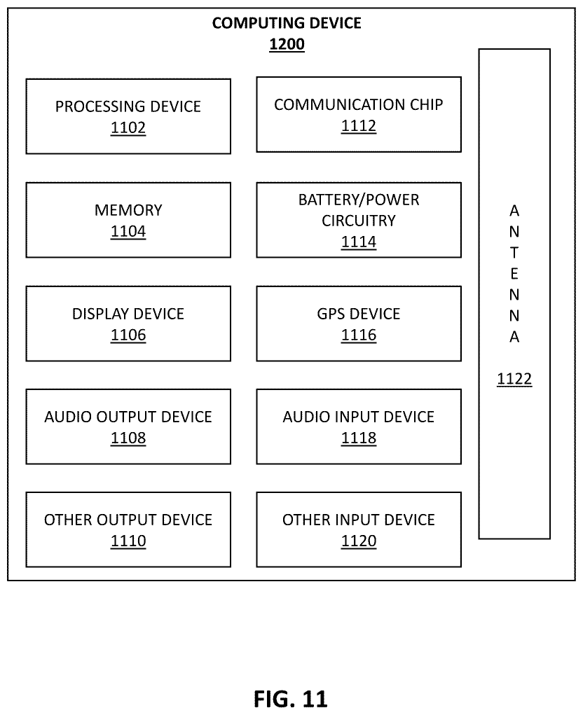

FIG. 11 is a block diagram of an example computing device 1100, in accordance with various embodiments. In some embodiments, the computing device 1100 can be used as at least part of the speculative decoding system 400 in FIG. 4. A number of components are illustrated in FIG. 11 as included in the computing device 1100, but any one or more of these components may be omitted or duplicated, as suitable for the application. In some embodiments, some or all of the components included in the computing device 1100 may be attached to one or more motherboards. In some embodiments, some or all of these components are fabricated onto a single system on a chip (SoC) die. Additionally, in various embodiments, the computing device 1100 may not include one or more of the components illustrated in FIG. 11, but the computing device 1100 may include interface circuitry for coupling to the one or more components. For example, the computing device 1100 may not include a display device 1106, but may include display device interface circuitry (e.g., a connector and driver circuitry) to which a display device 1106 may be coupled. In another set of examples, the computing device 1100 may not include an audio input device 1118 or an audio output device 1108 but may include audio input or output device interface circuitry (e.g., connectors and supporting circuitry) to which an audio input device 1118 or audio output device 1108 may be coupled.

The computing device 1100 may include a processing device 1102 (e.g., one or more processing devices). The processing device 1102 processes electronic data from registers and/or memory to transform that electronic data into other electronic data that may be stored in registers and/or memory. The computing device 1100 may include a memory 1104, which may itself include one or more memory devices such as volatile memory (e.g., DRAM), nonvolatile memory (e.g., ROM, high bandwidth memory (HBM), flash memory, solid state memory, and/or a hard drive. In some embodiments, the memory 1104 may include memory that shares a die with the processing device 1102. In some embodiments, the memory 1104 includes one or more non-transitory computer-readable media storing instructions executable to perform operations for DNN inference, such as operations performed by the IC device 100 in FIG. 1 or the model-on-silicon device 200 in FIG. 2. The instructions stored in the one or more non-transitory computer-readable media may be executed by the processing device 1102.

In some embodiments, the computing device 1100 may include a communication chip 1112 (e.g., one or more communication chips). For example, the communication chip 1112 may be configured for managing wireless communications for the transfer of data to and from the computing device 1100. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1112 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1112 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1112 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1112 may operate in accordance with other wireless protocols in other embodiments. The computing device 1100 may include an antenna 1122 to facilitate wireless communications and/or to receive other wireless communications (such as AM or FM radio transmissions).

In some embodiments, the communication chip 1112 may manage wired communications, such as electrical, optical, or any other suitable communication protocols (e.g., the Ethernet). As noted above, the communication chip 1112 may include multiple communication chips. For instance, a first communication chip 1112 may be dedicated to shorter-range wireless communications such as Wi-Fi or Bluetooth, and a second communication chip 1112 may be dedicated to longer-range wireless communications such as global positioning system (GPS), EDGE, GPRS, CDMA, WiMAX, LTE, EV-DO, or others. In some embodiments, a first communication chip 1112 may be dedicated to wireless communications, and a second communication chip 1112 may be dedicated to wired communications.

The computing device 1100 may include battery/power circuitry 1114. The battery/power circuitry 1114 may include one or more energy storage devices (e.g., batteries or capacitors) and/or circuitry for coupling components of the computing device 1100 to an energy source separate from the computing device 1100 (e.g., AC line power).

The computing device 1100 may include a display device 1106 (or corresponding interface circuitry, as discussed above). The display device 1106 may include any visual indicators, such as a heads-up display, a computer monitor, a projector, a touchscreen display, a liquid crystal display (LCD), a light-emitting diode display, or a flat panel display, for example.

The computing device 1100 may include an audio output device 1108 (or corresponding interface circuitry, as discussed above). The audio output device 1108 may include any device that generates an audible indicator, such as speakers, headsets, or earbuds, for example.

The computing device 1100 may include an audio input device 1118 (or corresponding interface circuitry, as discussed above). The audio input device 1118 may include any device that generates a signal representative of a sound, such as microphones, microphone arrays, or digital instruments (e.g., instruments having a musical instrument digital interface (MIDI) output).

The computing device 1100 may include a GPS device 1116 (or corresponding interface circuitry, as discussed above). The GPS device 1116 may be in communication with a satellite-based system and may receive a location of the computing device 1100, as known in the art.

The computing device 1100 may include another output device 1110 (or corresponding interface circuitry, as discussed above). Examples of the other output device 1110 may include an audio codec, a video codec, a printer, a wired or wireless transmitter for providing information to other devices, or an additional storage device.

The computing device 1100 may include another input device 1120 (or corresponding interface circuitry, as discussed above). Examples of the other input device 1120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1100 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1100 may be any other electronic device that processes data.

The following paragraphs provide various examples of the embodiments disclosed herein.

Example 1 provides an IC device, including a stack of embedding dies, an embedding die including an embedding dot unit configured to perform embedding computations in a DNN model; a stack of attention dies, an attention die including an attention dot unit configured to perform attention computations in a DNN model; and a base die, the base die configured to: perform one or more other types of computations in the DNN model, and orchestrate the embedding computations, the attention computations, and the one or more other types of computations.

Example 2 provides the IC device of example 1, in which the stack of embedding dies includes a first embedding die, a second embedding die, and a micro-bump between the first embedding die and the second embedding die.

Example 3 provides the IC device of example 1 or 2, in which the stack of attention dies includes a first attention die, a second attention die, and a micro-bump between the first attention die and the second attention die.

Example 4 provides the IC device of any one of examples 1-3, in which the embedding dot unit includes one or more multiply units and one or more add units, the one or more multiply units to perform multiplication operations on embeddings, the one or more add units to sum results of the multiplication operations.

Example 5 provides the IC device of example 4, in which the embedding dot unit further includes a sequential random-access memory or sequential ROM.

Example 6 provides the IC device of example 5, in which the sequential random-access memory or sequential ROM is to store weights of the DNN model or precomputed embedding vectors.

Example 7 provides the IC device of any one of examples 1-6, in which the attention dot unit includes one or more multiply units and one or more add units, the one or more multiply units to perform multiplication operations based on one or more attention mechanisms of the DNN model, the one or more add units to sum results of the multiplication operations.

Example 8 provides the IC device of example 7, in which the attention dot unit further includes a sequential random-access memory.

Example 9 provides the IC device of example 8, in which the sequential random-access memory is to store intermediate values of the DNN model, in which the intermediate values are dynamic values during inference of the DNN model.

Example 10 provides the IC device of any one of examples 1-9, further including a first electrical connection between the base die and the stack of embedding dies; and a second electrical connection between the base die and the stack of attention dies.

Example 11 provides an IC device, including an embedding die including an embedding dot unit configured to perform embedding computations in a DNN model; an attention die including an attention dot unit configured to perform attention computations in a DNN model; and a base die communicatively coupled to the embedding die and the attention die, the base die configured to: perform one or more other types of computations in the DNN model, and orchestrate the embedding computations, the attention computations, and the one or more other types of computations in accordance with a time sequence of the embedding computations, the attention computations, and the one or more other types of computations in the neural network model.

Example 12 provides the IC device of example 11, further including an additional embedding die stacked over the embedding die; and a micro-bump between the embedding die and the additional embedding die.

Example 13 provides the IC device of example 11 or 12, further including an additional attention die stacked over the attention die; and a micro-bump between the attention die and the additional attention die.

Example 14 provides the IC device of any one of examples 11-13, in which the embedding dot unit includes one or more multiply units and one or more add units, the one or more multiply units to perform multiplication operations on embeddings, the one or more add units to sum results of the multiplication operations.

Example 15 provides the IC device of example 14, in which the embedding dot unit further includes a sequential random-access memory or sequential ROM.

Example 16 provides the IC device of example 15, in which the sequential random-access memory or sequential ROM is to store weights of the DNN model or precomputed embedding vectors.

Example 17 provides the IC device of any one of examples 11-16, in which the attention dot unit includes one or more multiply units and one or more add units, the one or more multiply units to perform multiplication operations based on one or more attention mechanisms of the DNN model, the one or more add units to sum results of the multiplication operations.

Example 18 provides the IC device of example 17, in which the attention dot unit further includes a sequential random-access memory.

Example 19 provides the IC device of example 18, in which the sequential random-access memory is to store intermediate values of the DNN model, in which the intermediate values are dynamic values during inference of the DNN model.

Example 20 provides the IC device of any one of examples 11-19, further including a first electrical connection between the base die and the embedding die; and a second electrical connection between the base die and the attention die.

Example 21 provides a computing system, including a plurality of embedding dots units to implement a first type of operators in a neural network model, the plurality of embedding dots arranged in a stack of dies; a plurality of attention dot units to implement a second type of operators in a neural network model, the plurality of attention dots arranged in another stack of dies; one or more units to implement one or more other types of operators in the neural network model; and a flow control unit to orchestrate operations of the plurality of embedding dots units, the plurality of attention dot units, and the one or more units, in which the one or more units and the flow control units are arranged in a die separate from the stack of dies and the another stack of dies.

Example 22 provides the computing system of example 21, in which the first type of operators is matrix multiplication operators for embeddings converted from input tokens of the DNN model.

Example 23 provides the computing system of example 21 or 22, in which the second type of operators is matrix multiplication operators for attention mechanisms of the DNN model.

Example 24 provides the computing system of any one of examples 21-23, in which a die in the stack of dies or in the another stack of dies include one or more compute components and one or more memory components.

Example 25 provides the computing system of any one of examples 21-24, in which the stack of dies or the another stack of dies comprises one or more micro-bumps between the dies.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. An integrated circuit (IC) device, comprising:
a stack of embedding dies, an embedding die comprising an embedding dot unit configured to perform embedding computations in a neural network model;
a stack of attention dies, an attention die comprising an attention dot unit configured to perform attention computations in the neural network model; and
a base die, the base die configured to:
perform one or more other types of computations in the neural network model, and
orchestrate the embedding computations, the attention computations, and the one or more other types of computations.

2. The IC device of claim 1, wherein the stack of embedding dies comprises a first embedding die, a second embedding die, and a micro-bump between the first embedding die and the second embedding die.

3. The IC device of claim 1, wherein the stack of attention dies comprises a first attention die, a second attention die, and a micro-bump between the first attention die and the second attention die.

4. The IC device of claim 1, wherein the embedding dot unit comprises one or more multiply units and one or more add units, the one or more multiply units to perform multiplication operations on embeddings, the one or more add units to sum results of the multiplication operations.

5. The IC device of claim 4, wherein the embedding dot unit further comprises a sequential random-access memory or sequential read-only memory, the sequential random-access memory or sequential read-only memory to store weights of the neural network model or precomputed embedding vectors.

6. The IC device of claim 1, wherein the attention dot unit comprises one or more multiply units and one or more add units, the one or more multiply units to perform multiplication operations based on one or more attention mechanisms of the neural network model, the one or more add units to sum results of the multiplication operations.

7. The IC device of claim 6, wherein the attention dot unit further comprises a sequential random-access memory, the sequential random-access memory to store intermediate values of the neural network model, wherein the intermediate values are dynamic values during inference of the neural network model.

8. The IC device of claim 1, further comprising:
a first electrical connection between the base die and the stack of embedding dies; and
a second electrical connection between the base die and the stack of attention dies.

9. An integrated circuit (IC) device, comprising:
an embedding die comprising an embedding dot unit configured to perform embedding computations in a neural network model;
an attention die comprising an attention dot unit configured to perform attention computations in the neural network model; and
a base die communicatively coupled to the embedding die and the attention die, the base die configured to:
perform one or more other types of computations in the neural network model, and
orchestrate the embedding computations, the attention computations, and the one or more other types of computations in accordance with a time sequence of the embedding computations, the attention computations, and the one or more other types of computations in the neural network model.

10. The IC device of claim 9, further comprising:
an additional embedding die stacked over the embedding die; and
a micro-bump between the embedding die and the additional embedding die.

11. The IC device of claim 9, further comprising:
an additional attention die stacked over the attention die; and
a micro-bump between the attention die and the additional attention die.

12. The IC device of claim 9, wherein the embedding dot unit comprises one or more multiply units and one or more add units, the one or more multiply units to perform multiplication operations on embeddings, the one or more add units to sum results of the multiplication operations.

13. The IC device of claim 12, wherein the embedding dot unit further comprises a sequential random-access memory or sequential read-only memory, the sequential random-access memory or sequential read-only memory to store weights of the neural network model or precomputed embedding vectors.

14. The IC device of claim 9, wherein the attention dot unit comprises one or more multiply units and one or more add units, the one or more multiply units to perform multiplication operations based on one or more attention mechanisms of the neural network model, the one or more add units to sum results of the multiplication operations.

15. The IC device of claim 14, wherein the attention dot unit further comprises a sequential random-access memory, the sequential random-access memory to store intermediate values of the neural network model, wherein the intermediate values are dynamic values during inference of the neural network model.

16. The IC device of claim 9, further comprising:
a first electrical connection between the base die and the embedding die; and
a second electrical connection between the base die and the attention die.

17. A computing system, comprising:
a plurality of embedding dots units to implement a first type of operators in a neural network model, the plurality of embedding dots arranged in a stack of dies;
a plurality of attention dot units to implement a second type of operators in a neural network model, the plurality of attention dots arranged in another stack of dies;
one or more units to implement one or more other types of operators in the neural network model; and
a flow control unit to orchestrate operations of the plurality of embedding dots units, the plurality of attention dot units, and the one or more units,
wherein the one or more units and the flow control units are arranged in a die separate from the stack of dies and the another stack of dies.

18. The computing system of claim 17, wherein the first type of operators is matrix multiplication operators for embeddings converted from input tokens of the neural network model, wherein the second type of operators is matrix multiplication operators for attention mechanisms of the neural network model.

19. The computing system of claim 17, wherein a die in the stack of dies or in the another stack of dies include one or more compute components and one or more memory components.

20. The computing system of claim 17, wherein the stack of dies or the another stack of dies comprises one or more micro-bumps between the dies.
